(19) United States
(12) Patent Application Publication
(10) Pub. No.: US 2025/0274707 A1
(43) Pub. Date: Aug. 28, 2025

(54) VIBRATION APPARATUS AND VEHICULAR APPARATUS COMPRISING THE SAME

(71) Applicant: LG Display Co., Ltd., Seoul (KR)

(72) Inventors: YuSeon Kho, Paju-si (KR); Seunghyun Sung, Paju-si (KR); SeungRyull Park, Paju-si (KR)

(21) Appl. No.: 19/046,407

(22) Filed: Feb. 5, 2025

(30) Foreign Application Priority Data
Feb. 22, 2024 (KR) 10-2024-0025988

(51) Int. Cl. H04R 3/12

(52) U.S. Cl. CPC H04R 3/12; H04R 2499/13

(57) ABSTRACT

One or more embodiments of the present disclosure provides a vibration apparatus and a vehicular apparatus including the same. The vibration apparatus comprises a cover member having first and second areas, a vibration part in each of the first and second areas, and a support member between the cover member and the vibration part. The vibration apparatus and the vehicular apparatus including the same according to one or more embodiments of the present disclosure can prevent or minimize acoustic interference between multiple speakers, and can improve the directionality, the sound characteristics, and/or the sound pressure characteristics.

### CROSS-REFERENCE TO RELATED APPLICATIONS

This application claims the benefit of the Korean Patent Application No. 10-2024-0025988 filed on Feb. 22, 2024, which is hereby incorporated by reference as if fully set forth herein.

### BACKGROUND

### Technical Field

The present disclosure relates to a vibration apparatus and vehicular apparatus comprising the same.

### Description of the Related Art

Recently, a demand for a sound apparatus or a sound bar including a vibration apparatus for outputting sound through one or more speakers is increasing.

### BRIEF SUMMARY

However, the sound bar in the related art faces a problem where directionality, sound characteristics, and/or sound pressure characteristics are compromised due to sound interference among the plurality of speakers. The inventors of the present disclosure have recognized the problems and disadvantages of the related art and have performed extensive research and experiments for enhancing a directivity, a sound characteristic and/or a sound pressure level characteristic between multiple speakers. Based on the extensive research and experiments, the inventors have invented a vibration apparatus and a vehicular apparatus including the same, which can enhance a directivity, a sound characteristic and/or a sound pressure level characteristic.

One or more aspects of the present disclosure are directed to providing a vibration apparatus and a vehicular apparatus including the same, wherein acoustic interference between multiple speakers can be prevented or minimized.

One or more aspects of the present disclosure are directed to providing a vibration apparatus and a vehicular apparatus including the same, which can improve the directionality, the sound characteristics, and/or the sound pressure characteristics.

Additional features and advantages of the disclosure will be set forth in the description which follows and in part will be apparent from the description, or may be learned by practice of the disclosure. Other advantages of the present disclosure will be realized and attained by the structure particularly pointed out in the written description and claims hereof as well as the appended drawings.

To achieve these and other advantages and embodiment of the present disclosure, as embodied and broadly described herein, in one or more embodiments, a vibration apparatus comprises a cover member having first and second areas, a vibration part in each of the first and second areas, and a support member between the cover member and the vibration part.

To achieve these and other advantages and embodiment of the present disclosure, as embodied and broadly described herein, in one or more embodiments, a vehicular apparatus comprises an interior material exposed to an indoor space, and at least one sound generating apparatus configured to output sound to the indoor space. The at least one sound generating apparatus includes a vibration apparatus comprising a cover member having first and second areas, a vibration part in each of the first and second areas, and a support member between the cover member and the vibration part.

According to one or more aspects of the present disclosure, the vibration apparatus and the vehicular apparatus comprising the same may prevent or minimize the sound interference between the plurality of speakers.

According to one or more aspects of the present disclosure, the vibration apparatus and the vehicular apparatus comprising the same may improve the directionality, the sound characteristics, and/or the sound pressure characteristics.

According to one or more aspects of the present disclosure, the vibration apparatus and the vehicular apparatus comprising the same may improve the sound characteristics and/or the sound pressure characteristics so that it may be driven with low power, thereby reducing power consumption.

According to one or more aspects of the present disclosure, the vibration apparatus and the vehicular apparatus comprising the same may simplify the structure and may be easily designed.

An example vehicular apparatus according to one embodiment of the present disclosure includes: a body having a motor mounted therein; a plurality of vehicle interior materials coupled to the body; and a vibration apparatus coupled to at least one vehicle interior material of the plurality of vehicle interior materials.

The vibration apparatus includes: a cover member having first and second areas; a vibration part in each of the first and second areas; and a support member between the cover member and the vibration part.

The vibration part includes: a first vibration part in the first area; and a plurality of second vibration parts in the second area. Here, each of the plurality of second vibration parts is smaller than the first vibration part in size.

Additionally, each of the first vibration part and the plurality of second vibration parts includes: a vibration layer including a piezoelectric material; a first electrode layer on the first surface of the vibration layer; and a second electrode layer on the second surface of the vibration layer. The vibration layer has a first surface and a second surface different from the first surface, and the vibration layers of the first vibration part and the second vibration part have different sizes.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure and are incorporated in and constitute a part of this disclosure, illustrate aspects and embodiments of the disclosure and together with the description serve to explain principles of the disclosure.

FIG. 1 is a plan view illustrating a vibration apparatus according to an aspect of the present disclosure.

FIG. 2 is a cross-sectional view taken along line I-I′ of FIG. 1 according to an aspect of the present disclosure.

FIG. 3 is a plan view illustrating a vibration apparatus according to another aspect of the present disclosure.

FIG. 4 is a cross-sectional view taken along line II-II′ of FIG. 3 according to an aspect of the present disclosure.

FIG. 5 is a cross-sectional view taken along line II-II′ of FIG. 3 according to another aspect of the present disclosure.

FIG. 6 is a cross-sectional view taken along line II-II′ of FIG. 3 according to another aspect of the present disclosure.

FIGS. 7A and 7B are perspective views illustrating a support member shown in FIG. 6.

FIG. 8 is a diagram illustrating a sound apparatus according to an aspect of the present disclosure.

FIG. 9 is a diagram illustrating a sound apparatus according to another aspect of the present disclosure.

FIG. 10 is a diagram illustrating a vehicular apparatus according to an aspect of the present disclosure.

FIG. 11 is a diagram illustrating a vehicular apparatus according to an aspect of the present disclosure.

FIG. 12 is a diagram illustrating a sound generating apparatus disposed in the roof of the vehicular apparatus of FIGS. 10 and 11.

FIG. 13 is a diagram illustrating a sound generating apparatus disposed in the roof and seat of the vehicular apparatus of FIGS. 10 and 11.

### DETAILED DESCRIPTION

Reference is now made in detail to aspects of the present disclosure, examples of which can be illustrated in the accompanying drawings. In the following description, when a detailed description of well-known functions, structures or configurations can unnecessarily obscure aspects of the present disclosure, a detailed description of such known functions or configurations can have been omitted for brevity. Further, repetitive descriptions can be omitted for brevity. The progression of processing steps and/or operations described is a non-limiting example.

The sequence of steps and/or operations is not limited to that set forth herein and can be changed to occur in an order that is different from an order described herein, with the exception of steps and/or operations necessarily occurring in a particular order. In one or more examples, two operations in succession can be performed substantially concurrently, or the two operations can be performed in a reverse order or in a different order depending on a function or operation involved.

Unless stated otherwise, like reference numerals can refer to like elements throughout even when they are shown in different drawings. In one or more aspects, identical elements (or elements with identical names) in different drawings can have the same or substantially the same functions and properties unless stated otherwise. Names of the respective elements used in the following explanations are selected only for convenience and can be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure can be thorough and complete to assist those skilled in the art to understand the inventive concepts without limiting the protected scope of the present disclosure.

Shapes (e.g., sizes, lengths, widths, heights, thicknesses, locations, radii, diameters, and areas), dimensions, ratios, angles, numbers, and the like disclosed herein, including those illustrated in the drawings, are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

Where a term like “comprise,” “have,” “include,” “contain,” “constitute,” or the like is used with respect to one or more elements, one or more other elements can be added unless a term such as “only” or the like is used. The terms used in the present disclosure are merely used in order to describe example aspects, and are not intended to limit the scope of the present disclosure. The terms of a singular form can include plural forms unless the context clearly indicates otherwise.

The word “exemplary” is used to mean serving as an example or illustration, unless otherwise specified. Aspects are example aspects. “Embodiments,” “examples,” “aspects,” and the like should not be construed as preferred or advantageous over other implementations. An embodiment, an example, an example aspect, an aspect, or the like can refer to one or more aspects, one or more examples, one or more example embodiments, one or more embodiments, or the like, unless stated otherwise. Further, the term “may” encompasses all the meanings of the term “can.”

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range can be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more other parts can be located between the two parts unless a more limiting term, such as “immediate(ly),” “direct(ly),” or “close(ly),” is used. For example, where a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as, for example, “after,” “subsequent,” “next,” “before,” “preceding,” “prior to,” or the like, a case that is not consecutive or not sequential can be included and thus one or more other events can occur therebetween, unless a more limiting term, such as “just,” “immediate(ly),” or “direct(ly),” is used.

The terms, such as “below,” “lower,” “above,” “upper” and the like, can be used herein to describe a relationship between element(s) as illustrated in the drawings. It will be understood that the terms are spatially relative and based on the orientation depicted in the drawings.

It is understood that, although the terms “first,” “second,” or the like can be used herein to describe various elements (e.g., layers, films, regions, components, sections, or the like), these elements should not be limited by these terms, for example, to any particular order, precedence, or number of elements. These terms are used only to distinguish one element from another. For example, a first element could be termed a second element, and, similarly, a second element could be termed a first element, without departing from the scope of the present disclosure. Furthermore, the first element, the second element, and the like can be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element can include one or more first elements. Similarly, a second element or the like can include one or more second elements or the like.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) “overlaps,” or the like with another element, the element can not only directly contact, overlap, or the like with another element, but also indirectly overlap, or the like with another element with one or more intervening elements disposed or interposed between the elements, unless otherwise specified.

The phrase that an element (e.g., layer, film, region, component, section, or the like) is “provided in,” “disposed in,” or the like in another element can be understood as that at least a portion of the element is provided in, disposed in, or the like in another element, or that the entirety of the element is provided in, disposed in, or the like in another element. The phrase that an element (e.g., layer, film, region, component, section, or the like) “contacts,” “overlaps,” or the like with another element can be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other. Such terms can mean a wider range of lines or directions within which the components of the present disclosure can operate functionally. For example, the terms “first direction,” “second direction,” and the like, such as a direction parallel or perpendicular to “X-axis,” “Y-axis,” or “Z-axis,” should not be interpreted only based on a geometrical relationship in which the respective directions are parallel or perpendicular to each other, and can be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item”, can represent (i) a combination of items provided by two or more of the first item, the second item, and the third item or (ii) only one of the first item, the second item, or the third item.

The expression of a first element, a second elements, “and/or” a third element should be understood to encompass one of the first, second, and third elements, as well as any and all combinations of the first, second and third elements. By way of example, A, B and/or C encompass only A; only B; only C; any of A, B, and C (e.g., A, B, or C); some combinations of A, B, and C (e.g., A and B; A and C; or B and C); and all of A, B, and C. Furthermore, an expression “A/B” can be understood as A and/or B. For example, an expression “A/B” can refer to only A; only B; A or B; or A and B.

In one or more aspects, the terms “between” and “among” can be used interchangeably simply for convenience unless stated otherwise. For example, an expression “between a plurality of elements” can be understood as among a plurality of elements. In another example, an expression “among a plurality of elements” can be understood as between a plurality of elements. In one or more examples, the number of elements can be two. In one or more examples, the number of elements can be more than two. Furthermore, when an element (e.g., layer, film, region, component, sections, or the like) is referred to as being “between” at least two elements, the element can be the only element between the at least two elements, or one or more intervening elements can also be present.

In one or more aspects, the phrases “each other” and “one another” can be used interchangeably simply for convenience unless stated otherwise. For example, an expression “different from each other” can be understood as different from one another. In another example, an expression “different from one another” can be understood as different from each other. In one or more examples, the number of elements involved in the foregoing expression can be two. In one or more examples, the number of elements involved in the foregoing expression can be more than two.

In one or more aspects, the phrases “one or more among” and “one or more of” can be used interchangeably simply for convenience unless stated otherwise.

The term “or” means “inclusive or” rather than “exclusive or.” For example, unless otherwise stated or clear from the context, the expression that “x uses a or b” means any one of natural inclusive permutations. For example, “a or b” can mean “a,” “b,” or “a and b.” For example, “a, b or c” can mean “a,” “b,” “c,” “a and b,” “b and c,” “a and c,” or “a, b and c.”

Features of various aspects of the present disclosure can be partially or entirely coupled to or combined with each other, can be technically associated with each other, and can be operated, linked, or driven together in various ways. Aspects of the present disclosure can be implemented or carried out independently from each other, or can be implemented or carried out together in a co-dependent or related relationship. In one or more aspects, the components of each apparatus according to various aspects of the present disclosure can be operatively coupled and configured.

Unless otherwise defined, the terms (including technical and scientific terms) used herein have the same meaning as commonly understood by one of ordinary skill in the art to which example aspects belong. It should be further understood that terms, such as those defined in commonly used dictionaries, should be interpreted as having a meaning, for example, consistent with their meaning in the context of the relevant art and should not be interpreted in an idealized or overly formal sense, unless expressly defined otherwise herein.

The terms used herein have been selected as being general in the related technical field; however, there can be other terms depending on the development and/or change of technology, convention, preference of technicians, and so on. Therefore, the terms used herein should not be understood as limiting technical ideas, but should be understood as examples of the terms for describing example aspects.

Further, in a specific case, a term can be arbitrarily selected by an applicant, and in this case, the detailed meaning thereof is described herein. Therefore, the terms used herein should be understood based on not only the name of the terms, but also the meaning of the terms and the content hereof.

“X-axis direction”, “Y-axis direction” and “Z-axis direction” should not be construed by a geometric relation only of a mutual vertical relation and can have broader directionality within the range that elements of the present disclosure can act functionally.

In the following description, various example aspects of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements can be denoted by the same reference numerals even though they are depicted in different drawings.

In addition, for convenience of description, a scale, dimension, size, and thickness of each of the elements illustrated in the accompanying drawings can be different from an actual scale, dimension, size, and thickness, and thus, aspects of the present disclosure are not limited to a scale, dimension, size, and thickness illustrated in the drawings.

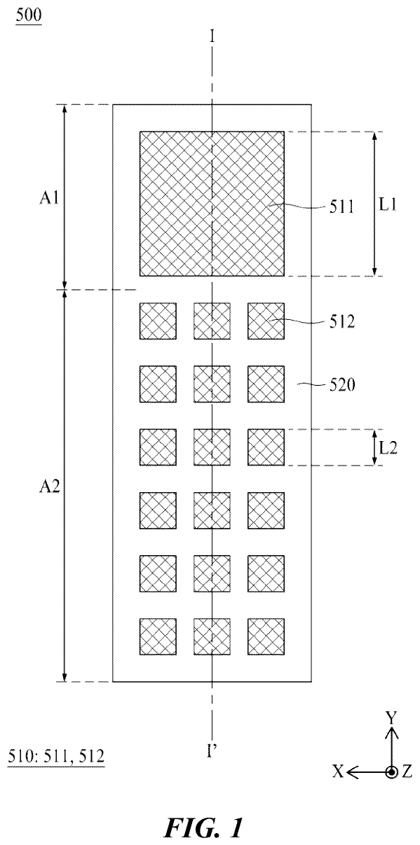

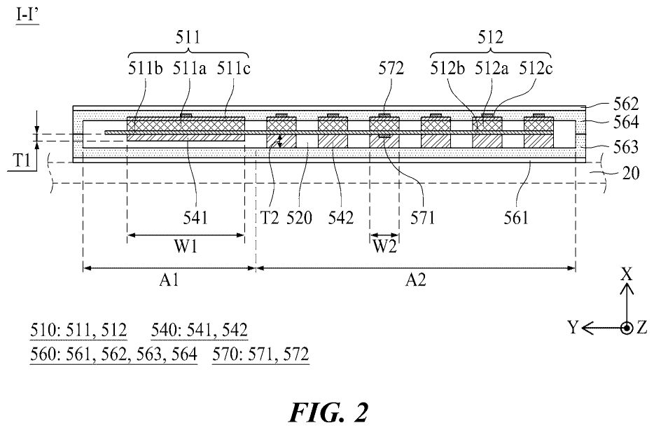

FIG. 1 is a plan view illustrating a vibration apparatus according to an aspect of the present disclosure. FIG. 2 is a cross-sectional view taken along line I-I′ of FIG. 1 according to an aspect of the present disclosure.

Referring to FIGS. 1 and 2, a vibration apparatus 500 according to an embodiment of the present disclosure may be configured to vibrate a vibration member 20. For example, the vibration apparatus 500 may be connected to the vibration member 20.

The vibration member 20 can generate a vibration or can output a sound (or a sound wave), based on the displacements (or driving) of the vibration apparatus 500. For example, the vibration member 20 can be a diaphragm, a vibration plate, a vibration object, a vibration panel, a sound plate, a sound panel, a passive vibration plate, a passive vibration member, a passive vibration panel, a sound output plate, or a sound vibration plate, but embodiments of the present disclosure are not limited thereto.

The vibration member 20 can include a single nonmetal material or a composite nonmetal material, but embodiments of the present disclosure are not limited thereto. For example, a single nonmetal material or a composite nonmetal material of the vibration member 20 can include one or more of wood, rubber, plastic, carbon, glass, fiber, cloth, paper, mirror, and leather, but embodiments of the present disclosure are not limited thereto. For example, the paper can be cone paper for speakers. For example, the cone paper can be pulp or foamed plastic, or the like, but embodiments of the present disclosure are not limited thereto.

According to an embodiment of the present disclosure, the vibration member 20 can be configured in a plastic material such as plastic or styrene material, but embodiments of the present disclosure are not limited thereto.

The plastic material of the vibration member 20 can be polyethylene terephthalate, polycarbonate, polyimide, polypropylene, polyarylate, polyethersulfone, polyethylene naphthalate, polysulfone, cyclo-olefin copolymer, or carbon fiber reinforced plastic CFRP, or the like, but embodiments of the present disclosure are not limited thereto.

The styrene material of the vibration member 20 can be an ABS material. The ABS material can be acrylonitrile, butadiene, or styrene.

A vibration member 20 according to an aspect of the present disclosure may be formed of a porous material. For example, the vibration member 20 may include a micro cellular plastics material. For example, the vibration member 20 may be formed of a micro cellular polyethylene terephthalate material MCPET. The vibration member 20 composed of MCPET has low density and excellent elasticity, whereby it has high sound reproduction capability, thereby improving sound quality.

According to an aspect of the present disclosure, the vibration member 20 may have a larger area than a vibration apparatus 500. The vibration apparatus 500 may be configured in a first surface (or upper surface) or a second surface (or lower surface) of the vibration member 20. The vibration apparatus 500 may have a shape corresponding to that of the vibration member 20 or may have a shape which is the same as that of the vibration member 20, but aspects of the present disclosure are not limited thereto. For example, the vibration apparatus 500 may have a different shape from the vibration member 20. For example, the vibration apparatus 500 may include a rectangular shape or a square shape, but aspects of the present disclosure are not limited thereto. For example, the vibration apparatus 500 may have a smaller size than the vibration member 20.

According to an aspect of the present disclosure, the vibration apparatus 500 may be disposed or configured in the vibration member 20. For example, the vibration apparatus 500 may be disposed or configured on one or more of the first surface and the second surface of the vibration member 20.

The vibration apparatus 500 can include a piezoelectric material having piezoelectric characteristic. The vibration apparatus 500 can vibrate (or displace or drive) based on driving signals (or a vibration driving signal or a voice signal) applied thereto to vibrate (or displace or drive) the vibration member (or a vehicular interior material). For example, the vibration apparatus 500 can vibrate (or displace or drive) by alternately repeating contraction and/or expansion by the piezoelectric effect (or piezoelectric property). For example, the vibration apparatus 500 can vibrate (or displace or drive) in the vertical direction (or thickness direction) Z by alternately repeating contraction and/or expansion by the inverse piezoelectric effect.

The vibration apparatus 500 may be formed of a ceramic-based piezoelectric material capable of generating a relatively strong vibration or may be formed of a piezoelectric ceramic material having a perovskite-based crystal structure. For example, the vibration apparatus 500 may be a vibration generating element, a vibration film, a vibration generating film, a vibrator, an active vibrator, an active vibration generator, an actuator, an exciter, a film actuator, a film exciter, an ultrasonic actuator, or an active vibration member, but aspects of the present disclosure are not limited thereto.

The vibration apparatus 500 according to an aspect of the present disclosure may include a vibration part 510, a support member 540, a flexible part 520, a cover member 560, and a signal cable 570.

The vibration part 510 may be configured to vibrate by a piezoelectric effect according to a driving signal. For example, the vibration part 510 may include a piezoelectric vibration portion. The vibration part 510 may include at least one of a piezoelectric inorganic material and a piezoelectric organic material, but aspects of the present disclosure are not limited thereto. For example, the vibration part 510 may be a vibration element, a piezoelectric element, a piezoelectric element portion, a piezoelectric element layer, a piezoelectric structure, a piezoelectric vibration part, or a piezoelectric vibration layer, but aspects of the present disclosure are not limited thereto.

The vibration part 510 may be configured in each of a first area A1 and a second area A2 of the cover member 560. The vibration part 510 may include a first vibration part 511 and a second vibration part 512. The first vibration part 511 may be configured in the first area A1 of the cover member 560. The second vibration part 512 may be configured in the second area A2 of the cover member 560. For example, the vibration part 510 may include one first vibration part 511 in the first area A1 of the cover member 560. For example, the vibration part 510 may include the plurality of second vibration parts 512 in the second area A2 of the cover member 560. The plurality of second vibration parts 512 may be configured in parallel to a first direction (or X-axis direction) and a second direction (or Y-axis direction) perpendicular to the first direction, but aspects of the present disclosure are not limited thereto. The first vibration part 511 and the second vibration part 512 may be spaced apart from each other by a predetermined distance. For example, each of the first vibration part 511 and the plurality of second vibration parts 512 may be disposed at fixed intervals.

The first area A1 may be smaller than the second area A2 in size. The first vibration part 511 and the second vibration part 512 may have different sizes. For example, the second vibration part 512 may have a smaller size than the first vibration part 511. For example, each of the plurality of second vibration parts 512 may have a smaller size than one first vibration part 511. For example, the first vibration part 511 and the second vibration part 512 may have a square shape, but aspects of the present disclosure are not limited thereto. For example, a length L2 of one side of the second vibration part 512 may be smaller than a length L1 of one side of the first vibration part 511. For example, the sound characteristics and/or sound pressure characteristics may be improved according as the size of the vibration part 510 increases, and the directionality may be improved according as the size of the vibration part 510 becomes small.

According to an aspect of the present disclosure, the first vibration part 511 and the second vibration part 512 are configured to have different sizes so that it is possible to prevent or minimize a sound interference between a plurality of speakers and to improve the directionality, the sound characteristics and/or the sound pressure characteristics. The vibration apparatus 500 according to an aspect of the present disclosure may be applied to a directional speaker.

According to the embodiment of the present disclosure, each of the first vibration part 511 and the plurality of second vibration part 512 can include a vibration layer 511a and 512a, a first electrode layer 511b and 512b, and a second electrode layer 511c and 512c.

The vibration layer 511a and 512a may include a piezoelectric material or an electroactive material including a piezoelectric effect. For example, the piezoelectric material may have a characteristic in which a potential difference is generated by dielectric polarization according to a change in the relative positions of positive (+) ions and negative (−) ions when a pressure or torsion phenomenon is applied to the crystal structure by an external force, and thus vibration is generated by an electric field according to a reverse voltage applied thereto. For example, the vibration layer 511a and 512a may be a piezoelectric layer, a piezoelectric material layer, an electrically active layer, a piezoelectric composite layer, a piezoelectric composite, or a piezoelectric ceramic composite, but aspects of the present disclosure are not limited thereto.

The vibration layers 511a and 512a may be made of a ceramic-based material capable of realizing a relatively strong vibration or a piezoelectric ceramic material having a perovskite-based crystal structure. The perovskite-based crystal structure may have a piezoelectric and/or reverse piezoelectric effect and may have a plate-shaped structure having orientation. The perovskite-based crystal structure may be represented by a chemical formula of ABO₃, wherein the A site may be formed of a divalent metal element, and the B site may be formed of a tetravalent metal element. As an aspect of the present disclosure, in a chemical formula of ABO₃, the A site and the B site may be cations, and O site may be anions. For example, the vibration layers 511a and 512a may include at least any one of PbTiO₃, PbZrO₃, PbZrTiO₃, BaTiO₃, and SrTiO₃, but aspects of the present disclosure are not limited thereto.

The piezoelectric ceramic may be formed of a single crystal ceramic having a single crystal structure, a ceramic material having a polycrystalline structure, or a polycrystalline ceramic. The piezoelectric material of the single crystal ceramic may include α-AlPO₄, α-SiO₂, LiNbO₃, Tb₂(MoO₄)₃, Li₂B₄O₇, or ZnO, but aspects of the present disclosure are not limited thereto. The piezoelectric material of the polycrystalline ceramic may include a lead zirconate titanate PZT-based material including lead Pb, zirconium Zr, and titanium Ti, or a lead zirconate nickel niobate PZNN-based material including lead Pb, zirconium Zr, nickel Ni, and niobium Nb, but aspects of the present disclosure are not limited thereto. For example, the vibration layers 511a and 512a may include at least one selected from the group of materials not including lead Pb, for example, at least one of CaTiO₃, BaTiO₃, and SrTiO₃, but aspects of the present disclosure are not limited thereto.

Each of the vibration layer 512a of the second vibration part 512 and the vibration layer 511a of the first vibration part 511 may have a square shape. The vibration layer 512a of the second vibration part 512 and the vibration layer 511a of the first vibration part 511 may have different sizes. For example, the size of the vibration layer 512a of the second vibration part 512 may be smaller than the size of the vibration layer 511a of the first vibration part 511. For example, the length of one side of the vibration layer 512a of the second vibration part 512 may be smaller than the length of one side of the vibration layer 511a of the first vibration part 511. For example, the length of one side of the vibration layer 512a of the second vibration part 512 may be in a range of 15% to 25% of the length of one side of the vibration layer 511a of the first vibration part 511, but aspects of the present disclosure are not necessarily limited thereto.

The first electrode layers 511b and 512b may be disposed on the first surface (or rear surface or lower surface) of the vibration layers 511a and 512a. The first electrode layers 511b and 512b may be disposed on the first surface (or rear surface or lower surface) of the vibration layer 511a of the first vibration part 511 and the vibration layer 512a of the second vibration part 512. For example, the first electrode layer 511b of the first vibration part 511 and the first electrode layer 512b of the second vibration part 512 adjacent to each other may be electrically connected to each other. For example, the plurality of first electrode layers 512b of the plurality of second vibration parts 512 adjacent to each other may be electrically connected to each other. For example, the first electrode layers 511b and 512b may be commonly disposed on or connected to the first surface (or lower surface) of the vibration layer 511a of the first vibration part 511 and the first surface (or lower surface) of each of the vibration layers 512a of the plurality of second vibration parts 512. For example, the first electrode layers 511b and 512b may have a cylindrical electrode shape disposed on the entire first surface (or lower surface) of each of the vibration layers 511a and 512a, but aspects of the present disclosure are not limited thereto.

The second electrode layers 511c and 512c may be disposed on the second surface (or front surface or upper surface) of the vibration layers 511a and 512a. The second electrode layers 511c and 512c may have the same size as the vibration layers 511a and 512a or may have a smaller size than the vibration layers 511a and 512a. For example, the second electrode layers 511c and 512c may have the same shape as the vibration layers 511a and 512a, but aspects of the present disclosure are not limited thereto.

At least one of the first electrode layers 511b and 512b and the second electrode layers 511c and 512c according to an aspect of the present disclosure may be formed of a transparent conductive material, a semi-transparent conductive material, or an opaque conductive material. For example, the transparent or semi-transparent conductive material may include indium tin oxide ITO or indium zinc oxide IZO, but aspects of the present disclosure are not limited thereto. The opaque conductive material may include gold Au, silver Ag, platinum Pt, palladium Pd, molybdenum Mo, magnesium Mg, carbon, or silver Ag containing glass frit, or an alloy thereof, but aspects of the present disclosure are not limited thereto. For example, each of the first electrode layers 511b and 512b and the second electrode layers 511c and 512c may include silver Ag having low resistivity in order to improve electrical characteristics and/or vibration characteristics of the vibration layers 511a and 512a. For example, carbon may be a carbon material including carbon black, ketjen black, carbon nanotubes, and graphite, but aspects of the present disclosure are not limited thereto.

The vibration layers 511a and 512a may be polarized (or poled) by a constant voltage applied to the first electrode layers 511b and 512b and the second electrode layers 511c and 512c under a constant temperature atmosphere or a temperature atmosphere which changes from a high temperature to a room temperature, but aspects of the present disclosure are not limited thereto. For example, the polarization direction (or poling direction) formed in the vibration layers 511a and 512a may be formed or aligned (or arranged) from the first electrode layers 511b and 512b to the second electrode layers 511c and 512c, but aspects of the present disclosure are not limited thereto. For example, the polarization direction (or the poling direction) formed in the vibration layers 511a and 512a may be formed or aligned (or arranged) from the second electrode layers 511c and 512c to the first electrode layers 511b and 512b.

The vibration layers 511a and 512a may vibrate by alternately repeating contraction and/or expansion due to a reverse piezoelectric effect according to a driving signal applied to the first electrode layers 511b and 512b and the second electrode layers 511c and 512c from the outside. For example, the vibration layers 511a and 512a may vibrate in the vertical direction (or thickness direction) and the plan direction by signals applied to the first electrode layers 511b and 512b and the second electrode layers 511c and 512c. The vibration layers 511a and 512a may be displaced (or vibrated or driven) by contraction and/or expansion in the plan direction, thereby improving the vibration characteristics including the sound characteristics and/or the sound pressure characteristics of the vibration apparatus 500.

The support member 540 may be configured between the cover member 560 and the vibration part 510. The support member 540 may be configured between a first cover member 561 and the first vibration part 511. The support member 540 may be configured between the first cover member 561 and the second vibration part 512. The thickness of the support member 540 may be 0.5 to 2.0 times the thickness of the vibration layers 511a and 512a, but aspects of the present disclosure are not limited thereto. For example, when the thickness of the support member 540 is less than 0.5 times the thickness of the vibration layers 511a and 512a, the support member 540 may be damaged by the vibration of the vibration layers 511a and 512a. For example, when the thickness of the support member 540 exceeds 2.0 times the thickness of the vibration layers 511a and 512a, the vibration of the vibration layers 511a and 512a may not be easily transmitted to the vibration member 20.

The support member 540 may be configured to support the vibration part 510 and to transmit the vibration of the vibration part 510 to the vibration member 20. For example, the support member 540 may be connected to the vibration part 510 and may be configured to adjust a resonance frequency of the vibration apparatus 500 to a band of about 40 kHz. For example, according to an aspect of the present disclosure, the resonance frequency of the vibration apparatus 500 may be lowered to the band of about 40 kHz by adjusting the material and thickness of the support member 540.

The support member 540 may be connected to the vibration part 510. The support member 540 may be connected to the first surface (or rear surface) of the first vibration part 511. The support member 540 may be connected to the first surface (or rear surface) of each of the plurality of second vibration parts 512. The support member 540 according to an aspect of the present disclosure may include a first support member 541 and a second support member 542.

The first support member 541 may transmit the vibration of the first vibration part 511 to the vibration member 20. The first support member 541 may be configured to adjust the resonance frequency of the first vibration part 511 to the band of about 40 kHz. The first support member 541 may be configured between the cover member 560 and the first vibration part 511. The first support member 541 may be configured between the first cover member 561 and the first vibration part 511. The first support member 541 may be connected to the first surface (or rear surface) of the first vibration part 511.

The first support member 541 may be configured to convert an in-plane vibration mode (or first vibration mode) of the first vibration part 511 into an out-of-plane vibration mode (or second vibration mode). For example, the first support member 541 may be configured to convert the in-plane vibration mode transmitted to the vibration member 20 into the out-of-plane vibration mode according to the vibration of the first vibration part 511. For example, the first support member 541 may be configured to convert the in-plane vibration mode according to the vibration of the first vibration part 511 to the out-of-plane vibration mode and to transmit the out-of-plane vibration mode to the vibration member 20. For example, the first support member 541 may be configured to convert an ultrasonic vibration direction vibration (or transverse vibration) transmitted to the vibration member 20 according to the vibration of the first vibration part 511 into a thickness direction vibration (or longitudinal vibration) of the vibration member 20. For example, the first support member 541 may be configured to convert the vibration of the first vibration part 511 into a normal direction vibration (or a transverse vibration) with respect to the surface of the first vibration part 511 or a thickness direction vibration (or longitudinal vibration) of the vibration member 20 and to transmit the vibration to the vibration member 20, thereby increasing (or maximizing) an efficiency of a squeeze film effect generated according to the vibration of the vibration member 20.

The second support member 542 may transmit the vibration of the second vibration part 512 to the vibration member 20. The second support member 542 may be configured to adjust a resonance frequency of the second vibration part 512 to a band of about 40 kHz. The second support member 542 may be configured between the cover member 560 and the second vibration part 512. The second support member 542 may be configured between the first cover member 561 and the plurality of second vibration parts 512. The second support member 542 may be connected to each of the first surfaces (or rear surfaces) of the plurality of second vibration parts 512. For example, the plurality of second support members 542 may be provided, but aspects of the present disclosure are not limited thereto. For example, each of the plurality of second support members 542 may be connected to each of the plurality of second vibration parts 512.

The second support member 542 may be configured to convert an in-plane vibration mode (or first vibration mode) of the second vibration part 512 into an out-of-plane vibration mode (or second vibration mode). For example, the second support member 542 may be configured to convert the in-plane vibration mode transmitted to the vibration member 20 into the out-of-plane vibration mode according to the vibration of the second vibration part 512. For example, the second support member 542 may be configured to convert the in-plane vibration mode according to the vibration of the second vibration part 512 into the out-of-plane vibration mode and to transmit the out-of-plane vibration mode to the vibration member 20. For example, the second support member 542 may be configured to convert an ultrasonic vibration direction vibration (or transverse vibration) transmitted to the vibration member 20 according to the vibration of the second vibration part 512 into a thickness direction vibration (or longitudinal vibration) of the vibration member 20. For example, the second support member 542 may convert the vibration of the second vibration part 512 into a normal direction vibration (or transverse vibration) with respect to the surface of the second vibration part 512 or a vibration (or longitudinal vibration) in the thickness direction of the vibration member 20 and to transmit the vibration to the vibration member 20, thereby increasing (or maximizing) an efficiency of a squeeze film effect generated according to the vibration of the vibration member 20.

According to an aspect of the present disclosure, the support member 540 may include at least any one of aluminum Al, copper Cu, and plastic, and the first support member 541 and the second support member 542 may include the same material. For example, the first support member 541 and the second support member 542 may include a metal material or a plastic material. For example, the metal material of the first support member 541 and the second support member 542 may include at least one of stainless steel, aluminum Al, aluminum Al alloy, magnesium Mg, magnesium Mg alloy, copper Cu alloy, and magnesium lithium Mg—Li alloy, but aspects of the present disclosure are not limited thereto. For example, the first support member 541 and the second support member 542 may be formed of a plastic material of a plastic or styrene material, but aspects of the present disclosure are not limited thereto. For example, the plastic material of the first support member 541 and the second support member 542 may be made of polypropylene, polycarbonate, polyethylene terephthalate, polyarylate, polyethylene naphthalate, polysulfone, polyethersulfone, or cyclo-olefin copolymer, but aspects of the present disclosure are not limited thereto. For example, the styrene material may be an ABS material. The ABS material may be Acrylonitrile, Butadiene, and Styrene.

According to an aspect of the present disclosure, the first support member 541 may have a size corresponding to the first vibration part 511 and the second support member 542 may have a size corresponding to the second vibration part 512, but aspects of the present disclosure are not limited thereto. For example, the first support member 541 may have a first width W1 corresponding to the first vibration part 511. For example, the second support member 542 may have a second width W2 corresponding to the second vibration part 512. However, aspects of the present disclosure are not necessarily limited thereto.

According to an aspect of the present disclosure, the thicknesses of the first support member 541 and the second support member 542 may be different from each other. For example, the thickness T1 of the first support member 541 may be smaller than the thickness T2 of the second support member 542, but aspects of the present disclosure are not limited thereto. For example, the thickness T1 of the first support member 541 may be 60% or less of the thickness T2 of the second support member 542.

For example, when the sizes of the first vibration part 511 and the second vibration part 512 are different from each other, the resonance frequencies of the ultrasonic waves output from the first vibration part 511 and the second vibration part 512 may be different from each other.

In the vibration apparatus 500 according to an aspect of the present disclosure, in order to set the resonance frequencies of the ultrasonic waves output from the first vibration part 511 and the second vibration part 512 to be similar to each other (or the range of 40 kHz to 43 kHz), the first support member 541 and the second support member 542 may include the same material and may have different thicknesses, but aspects of the present disclosure are not limited thereto.

Accordingly, the vibration apparatus 500 according to an aspect of the present disclosure may allow the ultrasonic waves output from the first vibration part 511 and the second vibration part 512 to have similar resonance frequencies. For example, the resonance frequency of the first vibration part 511 according to an aspect of the present disclosure may be 42.9 kHz, and the resonance frequency of the second vibration part 512 may be 42.5 kHz. Accordingly, the vibration apparatus 500 according to an aspect of the present disclosure may improve the sound and/or sound quality characteristics of the vibration apparatus 500 in the first vibration part 511, and may improve the directionality of the vibration apparatus 500 in the second vibration part 512.

The flexible part 520 may be configured to surround each of the first vibration part 511 and the second vibration part 512. The flexible part 520 may be configured between the first vibration part 511 and the second vibration part 512 adjacent to each other. The flexible part 520 may be configured between each of the plurality of second vibration parts 512. The flexible part 520 may be configured to surround the remaining surfaces of the vibration part 510 except for the upper and side surfaces of the second electrode layers 511c and 512c. The flexible part 520 may be configured to surround the side surface of the second support member 542. The flexible part 520 may be configured to surround the side and rear surfaces of the first support member 541.

According to an aspect of the present disclosure, since the vibration apparatus 500 includes the flexible part 520, vibration energy due to links in the unit lattice of the first vibration part 511 and the second vibration part 512 may be increased, and thus vibration characteristics may be enhanced, and piezoelectric characteristics and flexibility may be secured. For example, the flexible part 520 may be one or more of epoxy-based polymer, acryl-based polymer, and silicone-based polymer, but aspects of the present disclosure are not limited thereto.

For example, the flexible part 520 may include an organic material portion. For example, the organic material portion may be disposed between each of the vibration layers 511a and 512a including inorganic material portions so that it is possible to absorb an impact applied to the inorganic material portion (or vibration layer), to improve durability of the vibration part 510 by releasing stress concentrated on the inorganic material portion (or vibration layer), and to provide flexibility to the vibration part 510.

For example, the flexible part 520 may include an organic material, an organic polymer, an organic piezoelectric material, or an organic non-piezoelectric material having flexible characteristics compared to the vibration layers 511a and 512a, but aspects of the present disclosure are not limited thereto. For example, the flexible part 520 may be expressed as an adhesive portion having flexibility, an elastic portion, a bending portion, or a damping portion, but aspects of the present disclosure are not limited thereto.

According to an aspect of the present disclosure, the vibration apparatus 500 may be in the form of film, may vibrate in the up and down direction by the vibration part 510 having vibration characteristics, and may be bent in a curved shape by the flexible part 520 having flexibility. Also, in the vibration apparatus 500 according to an aspect of the present disclosure, the size of the flexible part 520 may be set according to the piezoelectric characteristics and flexibility required for the vibration apparatus 500. For example, in the case of the vibration apparatus 500 requiring piezoelectric characteristics rather than flexibility, the size of the flexible part 520 may be reduced. For example, in the case of the vibration apparatus 500 requiring flexibility rather than piezoelectric characteristics, the size of the flexible part 520 may be increased. For example, when the vibration apparatus 500 is attached to the curved vibration member 20, the shape of the flexible part 520 may be designed according to the shape of the vibration member 20 and the arrangement of the vibration part 510. Accordingly, the vibration apparatus 500 according to an aspect of the present disclosure may adjust the size and shape of the flexible part 520 according to the size of the vibration apparatus 500 and the shape of the vibration member 20, thereby facilitating design.

The vibration apparatus 500 according to an aspect of the present disclosure may include the cover member 560. The cover member 560 may include the first area A1 and the second area A2 adjacent to the first area A1. The cover member 560 may include the first cover member 561 and the second cover member 562.

The first cover member 561 may be disposed on the first surface (or lower surface) of the vibration part 510. The first vibration part 511 may be configured in the first area A1 of the first cover member 561, and the second vibration part 512 may be configured in the second area A2 of the first cover member 561. The first cover member 561 may be disposed on the first electrode layer 511b of the first vibration part 511 and the first electrode layer 512b of the second vibration part 512. For example, the first cover member 561 may be configured to cover the first electrode layer 511b of the first vibration part 511 and the first electrode layer 512b of the second vibration part 512. The support member 540 may be disposed between the first cover member 561 and the vibration part 510. For example, the first support member 541 may be configured between the first area A1 of the first cover member 561 and the first vibration part 511. For example, the second support member 542 may be configured in the second area A2 of the first cover member 561 and the second vibration part 512. The first cover member 561 may be disposed on the first support member 541 and the second support member 542. For example, the first cover member 561 may be configured to cover the first support member 541 and the second support member 542. For example, the first cover member 561 may be configured to have a larger size than each of the vibration part 510 and the support member 540, but aspects of the present disclosure are not limited thereto. The first cover member 561 may be configured to protect the first surface (or lower surface) of the vibration part 510 and the first electrode layers 511b and 512b. The first cover member 561 may be configured to protect the support member 540 connected to the vibration part 510.

The second cover member 562 may be disposed on the second surface (or upper surface) of the vibration part 510. The second cover member 562 may be configured in the second electrode layers 511c and 512c of the vibration part 510. For example, the second cover member 562 may be configured to cover the second electrode layers 511c and 512c of the vibration part 510. For example, the second cover member 562 may be in the second electrode layers 511c and 512c. For example, the second cover member 562 may be configured to have a larger size than the vibration part 510 and may be configured to have the same size as the first cover member 561. The second cover member 562 may be configured to protect the second surface (or upper surface) of the vibration part 510 and the second electrode layers 511c and 512c.

The first cover member 561 and the second cover member 562 according to an aspect of the present disclosure may include the same or different materials. For example, each of the first cover member 561 and the second cover member 562 may be a polyimide film, a polyethylene terephthalate film, or a polyethylene naphthalate film, but aspects of the present disclosure are not limited thereto.

The first cover member 561 may be connected or coupled to the first surface of the vibration part 510 and/or the first surface of the flexible part 520 through the use of first adhesive layer 563. For example, the first cover member 561 may be connected or coupled to the first surface of the vibration part 510, the support member 540, and/or the first surface of the flexible part 520 by a film laminating process using the first adhesive layer 563.

The second cover member 562 may be connected or coupled to the second surface or the second electrode layers 511c and 512c of the vibration part 510 through the use of second adhesive layer 564. For example, the second cover member 562 may be connected or coupled to the second surface or the second electrode layers 511c and 512c of the vibration part 510 by a film laminating process using the second adhesive layer 564.

According to an aspect of the present disclosure, each of the first adhesive layer 563 and the second adhesive layer 564 may include an electrically insulating material enabling compression and restoration while having adhesiveness. For example, each of the first adhesive layer 563 and the second adhesive layer 564 may include epoxy resin, acrylic resin, silicone resin, or urethane resin, but aspects of the present disclosure are not limited thereto.

The first adhesive layer 563 and the second adhesive layer 564 may be configured between the first cover member 561 and the second cover member 562 to surround the vibration part 510, the support member 540, and the flexible part 520. For example, at least one of the first adhesive layer 563 and the second adhesive layer 564 may be configured to surround the vibration part 510, the support member 540, and the flexible part 520.

The vibration apparatus 500 according to an aspect of the present disclosure may include the signal cable 570. The signal cable 570 may include a first power supply line (or first signal line) 571 disposed on the first cover member 561 and a second power supply line (or second signal line) 572 disposed on the second cover member 562.

The first power supply line 571 may be configured between the vibration part 510 and the first cover member 561. The first power supply line 571 may be configured between the first electrode layers 511b and 512b of the vibration part 510 and the first adhesive layer 563. The first power supply line 571 may be electrically connected to the first electrode layers 511b and 512b of the vibration part 510. For example, the first power supply line 571 may be electrically connected to the first electrode layers 511b and 512b of the vibration part 510 via an anisotropic conductive film. For example, the first power supply line 571 may be electrically connected to the first electrode layers 511b and 512b of the vibration part 510 through a conductive material (or particles).

The second power supply line 572 may be configured between the vibration part 510 and the second cover member 562. The second power supply line 572 may be configured between each of the second electrode layer 511c of the first vibration part 511 and the second electrode layer 512c of the second vibration part 512 and the second adhesive layer 564. The second power supply line 572 may be electrically connected to the second electrode layer 511c of the first vibration part 511. The second power supply line 572 may be electrically connected to each of the second electrode layers 512c in the plurality of second vibration parts 512. For example, the second power supply line 572 may be electrically connected to each of the second electrode layers 511c and 512c of the vibration part 510 via an anisotropic conductive film. For example, the second power supply line 572 may be electrically connected to each of the second electrode layers 511c and 512c of the vibration part 510 through a conductive material (or particle).

For example, the signal cable 570 may be electrically connected to a pad portion disposed in the vibration apparatus 500, and may supply a vibration driving signal (or sound signal) provided from a sound processing circuit to the vibration part 510. For example, the pad portion may include a flexible printed circuit cable, a flexible flat cable, a single-sided flexible printed circuit, a single-sided flexible printed circuit board, a flexible multilayer printed circuit, or a flexible multilayer printed circuit board, but aspects of the present disclosure are not limited thereto.

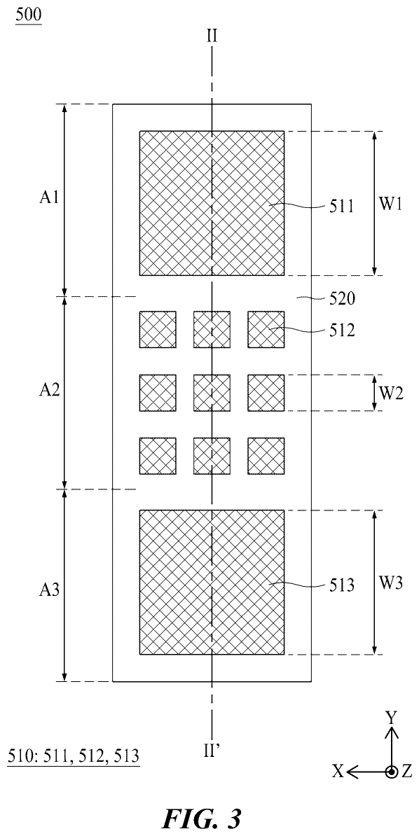

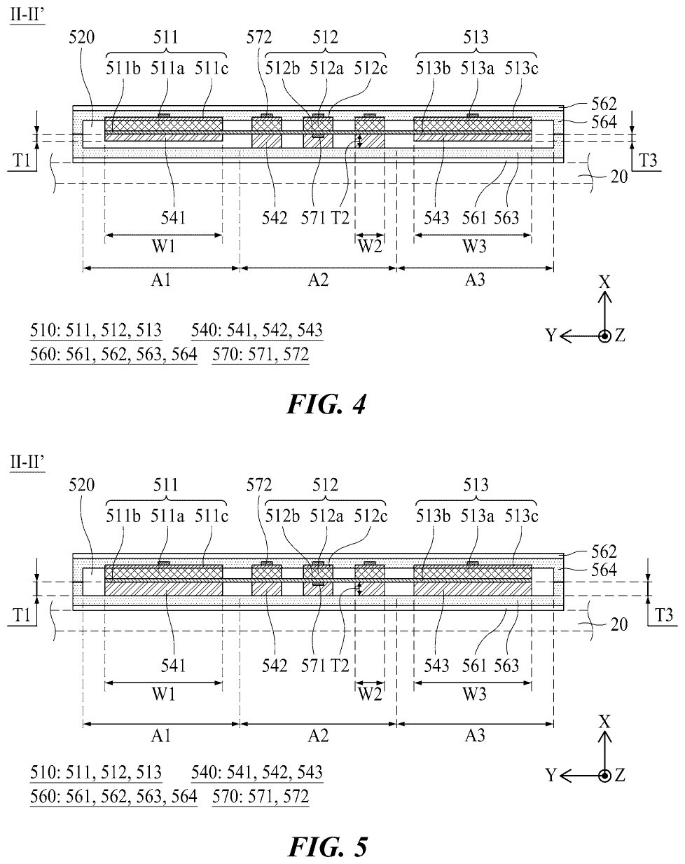

FIG. 3 is a plan view illustrating a vibration apparatus according to another aspect of the present disclosure. FIG. 4 is a cross-sectional view taken along line II-II′ of FIG. 3 according to another aspect of the present disclosure. This is substantially the same as the aspect of the present disclosure described with reference to FIGS. 1 and 2, except that a third area, a third vibration part, and a third support member are additionally provided in the cover member, the vibration part, and the support member, respectively. Thus, only different configurations will be described below.

Referring to FIGS. 3 and 4, a vibration part 510 according to another aspect of the present disclosure may be configured in each of a first area A1 to a third area A3 of a cover member 560. The vibration part 510 may include a first vibration part 511 to a third vibration part 513. The first to third vibration parts 511 to 513 may be respectively configured in the first to third areas A1 to A3.

According to another aspect of the present disclosure, the first to third areas A1, A2, and A3 may have the same size, but aspects of the present disclosure are not limited thereto. For example, the vibration part 510 may include one first vibration part 511 in the first area A1 of the cover member 560. For example, the vibration part 510 may include the plurality of second vibration parts 512 in the second area A2 of the cover member 560. For example, the vibration part 510 may include one third vibration part 513 in the third area A3 of the cover member 560.

The first vibration part 511 according to another aspect of the present disclosure may have substantially the same configuration as the first vibration part 511 according to the aspect of the present disclosure described with reference to FIGS. 1 and 2. The number of the plurality of second vibration parts 512 according to another aspect of the present disclosure is different from that of the aspect of the present disclosure described with reference to FIGS. 1 and 2, and the remaining components may have the same configuration as the second vibration part 512 according to the aspect of the present disclosure described with reference to FIGS. 1 and 2. Therefore, hereinafter, the third vibration part 513 and the configuration related to the third vibration part 513 will be described.

According to another aspect of the present disclosure, the first vibration part 511 and the third vibration part 513 may be configured with the second vibration part 512 therebetween, and may have the same size, but aspects of the present disclosure are not limited thereto. For example, the third vibration part 513 may have a square shape, but aspects of the present disclosure are not limited thereto. For example, a length of one side of the third vibration part 513 may be the same as a length of one side of the first vibration part 511.

The third vibration part 513 and the second vibration part 512 may have different sizes. For example, the second vibration part 512 may have a smaller size than the third vibration part 513. The vibration layers 511a and 513a of the first vibration part 511 and the third vibration part 513 may have the same size. The vibration layers 511a and 512a of the first vibration part 511 and the second vibration part 512 may have different sizes. The vibration layer 511a of the first vibration part 511 may be larger than the vibration layer 512a of the second vibration part 512 in size. For example, each of the plurality of second vibration parts 512 may have a smaller size than one third vibration part 513. For example, the third vibration part 513 and the second vibration part 512 may have a square shape, but aspects of the present disclosure are not limited thereto. For example, a length of one side of the second vibration part 512 may be smaller than the length of one side of the third vibration part 513, but aspects of the present disclosure are not limited thereto. For example, the sound characteristics and/or sound pressure characteristics may be improved according as the size of the vibration part 510 increases, and the directionality may be improved according as the size of the vibration part 510 becomes small.

According to the aspect of the present disclosure, the vibration apparatus 500 includes the second vibration part 512 having a different size from the first vibration part 511 and the third vibration part 513 having the same size, thereby preventing or minimizing a sound interference between a plurality of speakers and improving the directionality, the sound characteristics, and/or the sound pressure characteristics. The vibration apparatus 500 according to the aspect of the present disclosure may be applied to a directional speaker.

According to the aspect of the present disclosure, the third vibration part 513 may include a vibration layer 513a, a first electrode layer 513b, and a second electrode layer 513c. Herein, configurations of the vibration layer 513a, the first electrode layer 513b, and the second electrode layer 513c of the third vibration part 513 are substantially the same as those of the first vibration part 511.

According to another aspect of the present disclosure, the size of the vibration layer 512a of the second vibration part 512 may be smaller than the size of the vibration layer 513a of the third vibration part 513. For example, the length of one side of the vibration layer 512a of the second vibration part 512 may be smaller than the length of one side of the vibration layer 513a of the third vibration part 513, but aspects of the present disclosure are not limited thereto. For example, the length of one side of the vibration layer 512a of the second vibration part 512 may be 15% to 25% of the length of one side of the vibration layer 513a of the third vibration part 513, but the aspect of the present disclosure is not necessarily limited thereto.

The first electrode layers 511b, 512b, and 513b may be disposed on a first surface (or rear surface or lower surface) of the vibration layers 511a, 512a, and 513a. For example, the first electrode layer 511b of the first vibration part 511 and the first electrode layer 512b of the second vibration part 512 adjacent to each other may be electrically connected to each other. For example, the first electrode layer 513b of the third vibration part 513 and the first electrode layer 512b of the second vibration part 512 adjacent to each other may be electrically connected to each other. For example, the first electrode layers 511b, 512b, and 513b may be commonly disposed or connected to the first surface (or lower surface) of the vibration layer 511a of the first vibration part 511, the first surface (or lower surface) of each of the vibration layers 512a of the plurality of second vibration parts 512, and the first surface (or lower surface) of the vibration layer 513a of the third vibration part 513. For example, the first electrode layers 511b, 512b, and 513b may have a cylindrical electrode shape disposed on the entire first surface (or lower surface) of each of the vibration layers 511a, 512a, and 513a, but aspects of the present disclosure are not limited thereto.

The second electrode layer 511c, 512c, and 513c may be disposed on a second surface (or front surface or upper surface) of the vibration layer 511a, 512a, and 513a. The second electrode layers 511c, 512c, and 513c may have the same size as the vibration layers 511a, 512a, and 513a or may have a smaller size than the vibration layers 511a, 512a, and 513a. For example, the second electrode layers 511c, 512c, and 513c may have the same shape as the vibration layers 511a, 512a, and 513a, but aspects of the present disclosure are not limited thereto.

The vibration layer 513a, the first electrode layer 513b, and the second electrode layer 513c of the third vibration part 513 according to the aspect of the present disclosure may include the same material as the vibration layer 511a, the first electrode layer 511b, and the second electrode layer 511c of the first vibration part 511 described with reference to FIGS. 1 and 2 and may have the same characteristics.

According to another aspect of the present disclosure, a support member 540 may further include a third support member 543 formed between the cover member 560 and the vibration part 510. The third support member 543 may be configured between a first cover member 561 and the third vibration part 513. The third support member 543 may be configured to support the vibration part 510 and to transmit the vibration of the vibration part 510 to a vibration member 20. The third support member 543 may be connected to the vibration part 510. The third support member 543 may be connected to the first surface (or rear surface) of the third vibration part 513.

The third support member 543 may be configured to convert an in-plane vibration mode (or first vibration mode) of the third vibration part 513 into an out-of-plane vibration mode (or second vibration mode). For example, the third support member 543 may be configured to convert the in-plane vibration mode transmitted to the vibration member 20 into the out-of-plane vibration mode according to the vibration of the third vibration part 513. For example, the third support member 543 may be configured to convert the in-plane vibration mode according to the vibration of the third vibration part 513 into the out-of-plane vibration mode and transmit the out-of-plane vibration mode to the vibration member 20. For example, the third support member 543 may be configured to convert an ultrasonic vibration direction vibration (or transverse vibration) transmitted to the vibration member 20 according to the vibration of the third vibration part 513 into a thickness direction vibration (or longitudinal vibration) of the vibration member 20. For example, the third support member 543 may be configured to convert the vibration of the third vibration part 513 into a normal direction vibration (or transverse vibration) with respect to the surface of the third vibration part 513 or a thickness direction vibration (or longitudinal vibration) of the vibration member 20 and to transmit the vibration to the vibration member 20, thereby increasing (or maximizing) an efficiency of a squeeze film effect generated according to the vibration of the vibration member 20.

According to the aspect of the present disclosure, the third support member 543 may include the same material as the first support member 541, but aspects of the present disclosure are not limited thereto.

According to the aspect of the present disclosure, the third support member 543 may have a size corresponding to the third vibration part 513 and may have a third width W3 corresponding to the third vibration part 513, but aspects of the present disclosure are not limited thereto. For example, the third width W3 may be equal to the first width W1 and greater than the second width W2, but aspects of the present disclosure are not limited thereto.

According to the aspect of the present disclosure, the thicknesses of the third support member 543 and the first support member 541 may be the same, and the thicknesses of the third support member 543 and the second support member 542 may be different from each other. For example, the thicknesses T1 and T3 of each of the first support member 541 and the third support member 543 may be smaller than the thickness T2 of the second support member 542, but aspects of the present disclosure are not limited thereto. For example, each of the thicknesses T1 and T3 of the first support member 541 and the third support member 543 may be 60% or less of the thickness T2 of the second support member 542.

For example, when the sizes of the first vibration part 511 and the second vibration part 512 are different from each other, the resonance frequencies of the ultrasonic waves output from the first vibration part 511 and the second vibration part 512 may be different from each other. For example, when the sizes of the third vibration part 513 and the second vibration part 512 are different from each other, the resonance frequencies of the ultrasonic waves output from the third vibration part 513 and the second vibration part 512 may be different from each other.

In the vibration apparatus 500 according to the aspect of the present disclosure, in order to set the resonance frequencies of the ultrasonic waves output from the first vibration part 511 to the third vibration part 513 to be similar to each other (or the range of 40 kHz to 43 kHz), the first support member 541 to the third support member 543 may include the same material, and the second support member 542 having the different thickness may be disposed between the first support member 541 and the third support member 543.

Accordingly, the vibration apparatus 500 according to the aspect of the present disclosure may allow the ultrasonic waves output from the first vibration part 511 to the third vibration part 513 to have similar resonance frequencies. For example, the resonance frequency of the first vibration part 511 and the third vibration part 513 according to the aspect of the present disclosure may be 42.9 kHz, and the resonance frequency of the second vibration part 512 may be 42.5 kHz. Accordingly, the vibration apparatus 500 according to the aspect of the present disclosure may improve the sound and/or sound quality characteristics of the vibration apparatus 500 in the first vibration part 511 and the third vibration part 513 and may improve the directionality of the vibration apparatus 500 in the second vibration part 512. For example, the sound of low-pitched sound band may be output from the first vibration part 511 and the third vibration part 513, and the sound of high-pitched sound band may be output from the second vibration part 512.

The flexible part 520 may be configured to surround each of the first vibration part 511 to the third vibration part 513. The flexible part 520 may be configured between the second vibration part 512 and the third vibration part 513 adjacent to each other. The flexible part 520 may be configured to surround the remaining surfaces of the vibration part 510 except for the upper and side surfaces of the second electrode layers 511c, 512c, and 513c. The flexible part 520 may be configured to surround the side surface and the rear surface of the third support member 543.

According to the aspect of the present disclosure, since the vibration apparatus 500 includes the flexible part 520, vibration energy due to links in the unit lattice of the first vibration part 511 to the third vibration part 513 may be increased, and thus vibration characteristics may be enhanced, and piezoelectric characteristics and flexibility may be secured.

According to the aspect of the present disclosure, the cover member 560 may include the first area A1 to the third area A3. The first to third areas A1 to A3 may be configured in parallel. The first area A1 and the third area A3 may be spaced apart from each other with the second area A2 therebetween. The first to third areas A1 to A3 may have the same size, but aspects of the present disclosure are not limited thereto.

The first cover member 561 may include the first area A1 to the third area A3. The first cover member 561 may include the first area A1 to the third area A3 which are parallel to each other. The third vibration part 513 may be configured in the third area A3 of the first cover member 561. The first cover member 561 may be formed on the first electrode layer 511b of the first vibration part 511, the first electrode layer 512b of the second vibration part 512, and the first electrode layer 513b of the third vibration part 513. For example, the first cover member 561 may be configured to cover the first electrode layer 511b of the first vibration part 511, the first electrode layer 512b of the second vibration part 512, and the first electrode layer 513b of the third vibration part 513. For example, the third support member 543 may be configured between the third area A3 of the first cover member 561 and the third vibration part 513. The first cover member 561 may be configured in the third support member 543. For example, the first cover member 561 may be configured to cover the third support member 543. The first cover member 561 may be configured to protect the first surface (or lower surface) of the vibration part 510 and the first electrode layers 511b, 512b, and 513b. The first cover member 561 may be configured to protect the first to third support members 541, 542, and 543.

The second cover member 562 may be configured to cover the second electrode layers 511c, 512c, and 513c of the vibration part 510. For example, the second cover member 562 may be in the second electrode layers 511c, 512c, and 513c. The second cover member 562 may be configured to protect the second surface (or upper surface) of the vibration part 510 and the second electrode layers 511c, 512c, and 513c.

The second cover member 562 may be connected or coupled to the second surface of the vibration part 510 or the second electrode layers 511c, 512c, and 513c via the second adhesive layer 564. For example, the second cover member 562 may be connected or coupled to the second surface of the vibration part 510 or the second electrode layers 511c, 512c, and 513c by a film laminating process using the second adhesive layer 564.

A first power supply line 571 according to another aspect of the present disclosure may be configured between the first electrode layers 511b, 512b, and 513b of the vibration part 510 and the first adhesive layer 563. The first power supply line 571 may be electrically connected to the first electrode layers 511b, 512b, and 513b of the vibration part 510. For example, the first power supply line 571 may be electrically connected to the first electrode layers 511b, 512b, and 513b of the vibration part 510 via an anisotropic conductive film. For example, the first power supply line 571 may be electrically connected to the first electrode layers 511b, 512b, and 513b of the vibration part 510 through a conductive material (or particles).

A second power supply line 572 according to another aspect of the present disclosure may be configured between each of the second electrode layer 511c of the first vibration part 511, the second electrode layer 512c of the second vibration part 512, and the second electrode layer 513c of the third vibration part 513 and the second adhesive layer 564. The second power supply line 572 may be electrically connected to the second electrode layer 513c of the third vibration part 513.

FIG. 5 is a cross-sectional view taken along line II-II′ of FIG. 3 according to another aspect of the present disclosure. In FIG. 5, the configuration of the support member is changed, and the remaining configuration other than the support member may be substantially the same as the other aspect described with reference to FIGS. 3 and 4. Accordingly, different configurations will be described below.

Referring to FIGS. 3 and 5, the support member 540 according to another aspect of the present disclosure may include first to third support members 541, 542, and 543 formed between a cover member 560 and a vibration part 510.

According to another aspect of the present disclosure, the first support member 541 and the third support member 543 may include the same material, but aspects of the present disclosure are not limited thereto. The first support member 541 and the second support member 542 may include different materials, but aspects of the present disclosure are not limited thereto. The third support member 543 and the second support member 542 may include different materials, but aspects of the present disclosure are not limited thereto. For example, the first support member 541 and the third support member 543 may include copper Cu, and the second support member 542 may include aluminum Al, but aspects of the present disclosure are not limited thereto. For example, the first to third support members 541, 542 and 543 may have the same thickness T1, T2, and T3, but aspects of the present disclosure are not limited thereto.

For example, when the sizes of the first vibration part 511 and the second vibration part 512 are different from each other, the resonance frequencies of the ultrasonic waves output from the first vibration part 511 and the second vibration part 512 may be different from each other. For example, when the sizes of the third vibration part 513 and the second vibration part 512 are different from each other, the resonance frequencies of the ultrasonic waves output from the third vibration part 513 and the second vibration part 512 may be different from each other.

In the vibration apparatus 500 according to another aspect of the present disclosure, in order to set the resonance frequencies of the ultrasonic waves output from the first vibration part 511 to the third vibration part 513 to be similar to each other (or the range of 40 kHz to 43 kHz), the first support member 541 and the third support member 543 may be made with the material different from that of the second support member 542, and the second support member 542 of the different material may be configured between the first support member 541 and the third support member 543.

Accordingly, the vibration apparatus 500 according to another aspect of the present disclosure may allow the ultrasonic waves output from the first vibration part 511 to the third vibration part 513 to have similar resonance frequencies. For example, according to another aspect of the present disclosure, the resonance frequency of the first vibration part 511 and the third vibration part 513 may be 42.9 kHz, and the resonance frequency of the second vibration part 512 may be 42.5 kHz. Accordingly, the vibration apparatus 500 according to the aspect of the present disclosure may improve the sound quality characteristics of the vibration apparatus 500 in the first vibration part 511 and the third vibration part 513 and may improve the directionality of the vibration apparatus 500 in the second vibration part 512. The vibration apparatus 500 according to the aspect of the present disclosure may be applied to a directional speaker.

According to another aspect of the present disclosure, since the thicknesses of the first support member 541 to the third support member 543 are the same, the flexible part 520 may be configured to surround the side surfaces of the first support member 541 to the third support member 543.

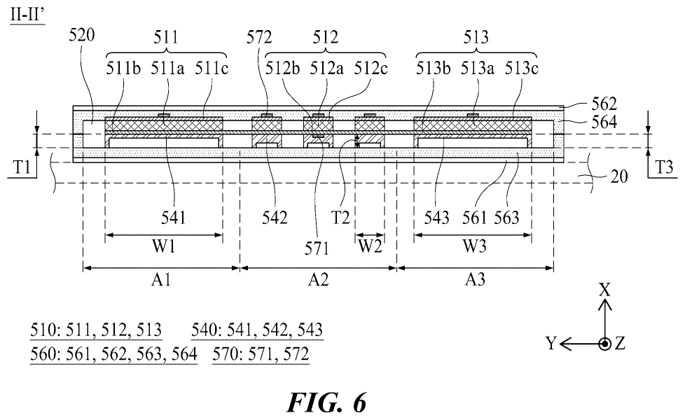

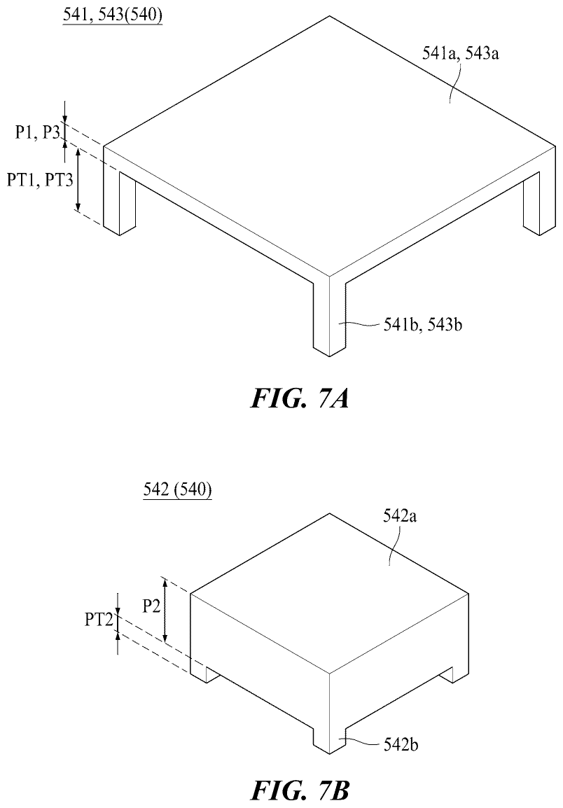

FIG. 6 is a cross-sectional view taken along line II-II′ of FIG. 3 according to another aspect of the present disclosure. FIGS. 7A and 7B are perspective views illustrating a support member shown in FIG. 6. This may be substantially the same as the other aspects of the present disclosure described with reference to FIGS. 3 and 4, except that the configuration of the support member is changed. Thus, different configurations will be described as follows.

Referring to FIGS. 3, 6, 7A, and 7B, the support member 540 according to another aspect of the present disclosure may further include first to third support members 541, 542, and 543 configured between a cover member 560 and a vibration part 510. For example, the first to third support members 541, 542, and 543 may include the same material, but aspects of the present disclosure are not limited thereto.

According to another aspect of the present disclosure, the first to third support members 541, 542, and 543 may include support plates 541a, 542a, and 543a and protrusions 541b, 542b, and 543b, respectively.

According to the aspect of the present disclosure, each of the support plates 541a, 542a, and 543a may support each of first to third vibration parts 511, 512, and 513. The respective support plates 541a, 542a, and 543a may have the same size as the first to third vibration parts 511, 512, and 513, but aspects of the present disclosure are not limited thereto. For example, the thicknesses of the support plates 541a and 543a respectively provided in the first support member 541 and the third support member 543 may be the same, but aspects of the present disclosure are not limited thereto. For example, the thicknesses of the support plates 541a and 542a respectively provided in the first support member 541 and the second support member 542 may be different from each other, but aspects of the present disclosure are not limited thereto. For example, the support plate 541a of the first support member 541 and the support plate 542a of the second support member 542 may have different thicknesses, but aspects of the present disclosure are not limited thereto. For example, the thickness P1 of the support plate 541a of the first support member 541 may be smaller than the thickness P2 of the support plate 542a of the second support member 542, but aspects of the present disclosure are not limited thereto. For example, the thicknesses of the support plates 543a and 542a in the third support member 543 and the second support member 542 may be different from each other, but aspects of the present disclosure are not limited thereto. For example, the support plate 543a of the third support member 543 and the support plate 542a of the second support member 542 may have different thicknesses, but aspects of the present disclosure are not limited thereto. For example, the thickness P3 of the support plate 543a of the third support member 543 may be smaller than the thickness P2 of the support plate 542a of the second support member 542, but aspects of the present disclosure are not limited thereto.

According to the aspect of the present disclosure, each of the protrusions 541b, 542b, and 543b may vertically protrude from each of the support plates 541a, 542a, and 543a. For example, each of the protrusions 541b, 542b, and 543b may support each of the support plates 541a, 542a, and 543a. Each of the support plates 541a, 542a, and 543a may be configured with a pair of protrusions 541b, 542b, and 543b vertically configured from facing sides. For example, the thicknesses PT1 and PT3 of the protrusions 541b and 543b in the first support member 541 and the third support member 543 may be the same, but aspects of the present disclosure are not limited thereto. For example, the thicknesses PT1 and PT2 of the protrusions 541b and 542b in the first support member 541 and the second support member 542 may be different from each other, but aspects of the present disclosure are not limited thereto. For example, the thicknesses PT1 and PT2 of the protrusion 541b in the first support member 541 and the protrusion 542b in the second support member 542 may be different from each other, but aspects of the present disclosure are not limited thereto. For example, the thickness PT1 of the protrusion 541b of the first support member 541 may be greater than the thickness PT2 of the protrusion 542b of the second support member 542, but aspects of the present disclosure are not limited thereto. For example, the thicknesses PT3 and PT2 of the protrusions 543b and 542b in the third support member 543 and the second support member 542 may be different from each other, but aspects of the present disclosure are not limited thereto. For example, the protrusions 543b of the third support member 543 and the protrusions 542b of the second support member 542 may have different thicknesses PT3 and PT2, but aspects of the present disclosure are not limited thereto. For example, the thickness PT3 of the protrusion 543b of the third support member 543 may be greater than the thickness PT2 of the protrusion 542b of the second support member 542, but aspects of the present disclosure are not limited thereto.

For example, when the sizes of the first vibration part 511 and the second vibration part 512 are different from each other, the resonance frequencies of the ultrasonic waves output from the first vibration part 511 and the second vibration part 512 may be different from each other. For example, when the sizes of the third vibration part 513 and the second vibration part 512 are different from each other, the resonance frequencies of the ultrasonic waves output from the third vibration part 513 and the second vibration part 512 may be different from each other.

In the vibration apparatus 500 according to the aspect of the present disclosure, in order to set the resonance frequencies of the ultrasonic waves output from the first vibration part 511 to the third vibration part 513 to be similar to each other (or the range of 40 kHz to 43 kHz), the first support member 541 to the third support member 543 may include the same material, and the second support member 542 may be disposed between the first support member 541 and the third support member 543.

Also, the vibration apparatus 500 according to another aspect of the present disclosure may be configured such that the first to third support members 541, 542, and 543 includes the support plates 541a, 542a, and 543a and the protrusions 541b, 542b, and 543b, and the thicknesses of the support plates 541a, 542a, and 543a and the protrusions 541b, 542b, and 543b in the respective support members 541, 542, 543 may be adjusted.

Accordingly, the vibration apparatus 500 according to the aspect of the present disclosure may allow the ultrasonic waves output from the first vibration part 511 to the third vibration part 513 to have similar resonance frequencies. For example, the resonance frequency of the first vibration part 511 and the third vibration part 513 according to the aspect of the present disclosure may be 42.9 kHz, and the resonance frequency of the second vibration part 512 may be 42.5 kHz. Accordingly, the vibration apparatus 500 according to the aspect of the present disclosure may improve the sound characteristics and/or sound quality characteristics of the vibration apparatus 500 in the first vibration part 511 and the third vibration part 513 and may improve the directionality of the vibration apparatus 500 in the second vibration part 512. The vibration apparatus 500 according to the aspect of the present disclosure may be applied to a directional speaker.

According to another aspect of the present disclosure, the flexible part 520 may be configured to surround each of the first vibration part 511 to the third vibration part 513. The flexible part 520 may be between the first vibration part 511 and the second vibration part 512 adjacent to each other and between the second vibration part 512 and the third vibration part 513. The flexible part 520 may be disposed on a rear surface of the support plate 541a and 543a in each of the first support member 541 and the third support member 543. The flexible part 520 may be configured to surround the rear surface of each of the first vibration part 511 to the third vibration part 513. The flexible part 520 may be filled between the rear surface of the support plate 541a of the first support member 541 and the facing protrusion 541b. The flexible part 520 may be filled between the rear surface of the support plate 542a of the second support member 542 and the facing protrusion 542b. The flexible part 520 may be filled between the rear surface of the support plate 543a of the third support member 543 and the facing protrusion 543b.

According to another aspect of the present disclosure, the first cover member 561 may be configured to protect the first surface (or lower surface) of the vibration part 510 and the first electrode layers 511b, 512b, and 513b. The first cover member 561 may be configured to protect the first to third support members 541, 542, and 543. The first cover member 561 may be configured in the first to third support members 541, 542, and 543. The first cover member 561 may cover the first to third support members 541, 542, and 543.

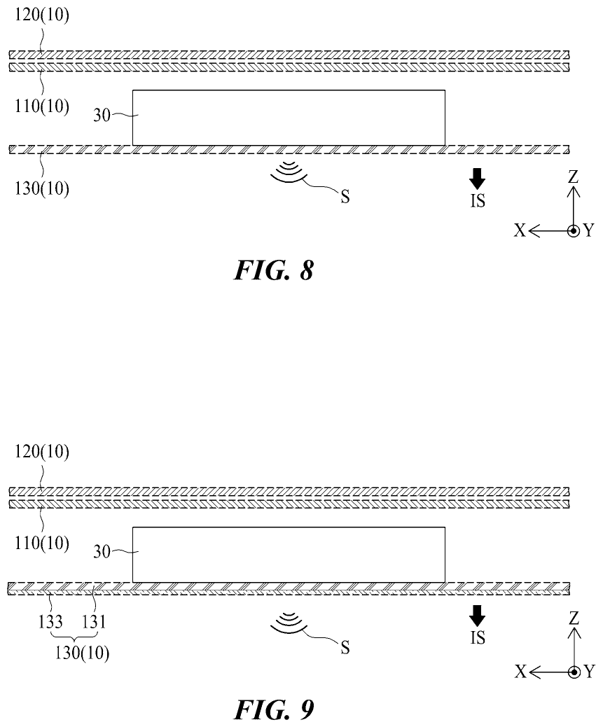

FIG. 8 is a diagram illustrating a sound apparatus according to an aspect of the present disclosure. FIG. 8 illustrates a vehicular sound apparatus according to an embodiment of the present disclosure.

Referring to FIG. 8, a sound apparatus 30 according to an embodiment of the present disclosure can be disposed or equipped at an inner portion of a vehicle 10 to output a sound S toward an indoor space IS of the vehicle 10.

The vehicle 10 can be a vehicular apparatus including one or more seats and one or more windows. For example, the vehicle 10 can include an automobile, a train, a ship, or an aircraft, but the embodiments of the present disclosure are not limited thereto.

The vehicle 10 according to an embodiment of the present disclosure can include a main structure 110.

The main structure 110 of the vehicle 10 can include a main frame, a sub-frame, a side frame, a door frame, an under frame, a seat frame, etc., but the embodiments of the present disclosure are not limited thereto. For example, the main structure 110 can be a body, a vehicle structure, a frame structure, etc., but the embodiments of the present disclosure are not limited thereto.

The vehicle 10 according to the embodiment of the present disclosure can further include an exterior material 120.

The exterior material 120 of the vehicle 10 can be configured to cover the main structure 110. For example, the exterior material 120 can be configured to cover the exterior of the main structure 110. In the following description, the exterior material 120 can be a vehicle exterior material 120, and these may be used interchangeably.

The exterior material 120 of the vehicle 10 can include a hood panel, a front fender panel, a dash panel, a filler panel, a trunk panel, a roof panel (or a ceiling), a floor panel, a door inner panel, a door outer panel, and the like, but the embodiments of the present disclosure are not limited thereto.

The exterior material 120 according to the embodiment of the present disclosure can include at least one of a flat portion and a curved portion (or a bent portion). For example, the exterior material 120 can have a structure corresponding to the structure of the corresponding main structure 110 or can have a structure different from the structure of the corresponding main structure 110.

The vehicle 10 according to the embodiment of the present disclosure can further include an interior material 130. In the following description, the interior material 130 can be referred to as a vehicle interior material 130, and these may be used interchangeably.

The vehicle interior material 130 can include all elements configuring an inner portion of the vehicle 10, or can include all elements disposed at the indoor space IS of the vehicle 10. For example, the vehicle interior material 130 can be an interior member or an inner finish material of the vehicle 10, but embodiments of the present disclosure are not limited thereto.

The vehicle interior material 130 according to the embodiment of the present disclosure can be configured to cover at least one of the main structure 110 and the exterior material 120 in the indoor space IS of the vehicle 10. For example, the interior material 130 can be configured to be exposed to the indoor space IS of the vehicle 10 while covering at least one of the main structure 110 and the exterior material 120 in the indoor space IS of the vehicle 10.

The vehicle interior material 130 according to an embodiment of the present disclosure can be exposed at the inner portion or the indoor space IS of the vehicle 10 in the inner portion or the indoor space IS of the vehicle 10. For example, the vehicle interior material 130 can be configured to cover one surface (or an interior surface) of at least one or more of a main frame (or a vehicle body), a side frame (or a side body), a door frame (or a door body), a handle frame (or a steering hub), and a seat frame, which are exposed at the indoor space IS of the vehicle 10.

The vehicle interior material 130 according to an embodiment of the present disclosure can include a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an indoor illumination interior material), a rear view mirror, a glove box, and a sun visor, or the like, but embodiments of the present disclosure are not limited thereto.

The vehicle interior material 130 according to an embodiment of the present disclosure can include one or more materials of metal, wood, rubber, plastic, glass, fiber, cloth, paper, a mirror, leather, and carbon, but embodiments of the present disclosure are not limited thereto. The vehicle interior material 130 including a plastic material can be an injection material which is implemented by an injection process using a thermoplastic resin or a thermosetting resin, but embodiments of the present disclosure are not limited thereto. The vehicle interior material 130 including a fiber material can include at least one or more of a plastic composite fiber, a carbon fiber (or an aramid fiber), and a natural fiber, but embodiments of the present disclosure are not limited thereto. The vehicle interior material 130 including the fiber material can include a textile sheet, a knit sheet, or a nonwoven fabric, or the like, but embodiments of the present disclosure are not limited thereto. For example, the paper can be cone paper for speakers. For example, the cone paper can be pulp or foamed plastic, or the like, but embodiments of the present disclosure are not limited thereto. The vehicle interior material 130 including a leather material can include natural leather or artificial leather, but embodiments of the present disclosure are not limited thereto.

The vehicle interior material 130 according to an embodiment of the present disclosure can include at least one or more of a flat portion (or flat surface portion) and a curved portion (or curved surface portion). For example, the vehicle interior material 130 can have a surface structure corresponding to a surface structure of a corresponding vehicle structure, or can have a surface structure which differs from a surface structure of a corresponding vehicle structure.

According to an embodiment of the present disclosure, the sound apparatus 30 can be disposed at the vehicle interior material 130. The sound apparatus 30 can vibrate the vehicle interior material 130 to generate a sound S based on a vibration of the vehicle interior material 130. For example, the sound apparatus 30 can directly vibrate the vehicle interior material 130 to generate the sound S based on a vibration of the vehicle interior material 130. For example, the sound apparatus 30 can be configured to vibrate the vehicle interior material 130 to output the sound S toward an inner portion or an indoor space IS of the vehicle 10. Thus, the sound apparatus 30 can use the vehicle interior material 130 as a sound vibration plate or an acoustic diaphragm. The vehicle interior material 130 can perform a function of a vibration plate, a sound vibration plate, or a sound generating plate for outputting the sound S. For example, the vehicle interior material 130 can have a size which is greater than the sound apparatus 30, but embodiments of the present disclosure are not limited thereto.

According to an embodiment of the present disclosure, the sound apparatus 30 can be disposed in at least one or more of a dashboard, a pillar interior material, a floor interior material, a roof interior material, a door interior material, a handle interior material, and a seat interior material, or can be positioned or connected (or coupled) to at least one of a rear package interior material, an overhead console, a rear view mirror, a glove box, and a sun visor. For example, the sound apparatus 30 can be configured to vibrate (or directly vibrate) at least one or more of a dashboard, a pillar interior material, a floor interior material, a roof interior material, a door interior material, a handle interior material, a seat interior material, a rear package interior material, an overhead console, a rear view mirror, a glove box, and a sun visor to output sound S toward the interior and/or indoor space IS of the vehicle 10.

A vehicle 10 according to an embodiment of the present disclosure can include one or more sound apparatus 30 arranged at or connected to at least one area (or part) of a vehicle interior material 130. The one or more sound apparatus 30 can vibrate at least one area (or part) of the vehicle interior material 130 to output realistic sound S and/or three-dimensional sound including multi-channels toward the indoor space IS of the vehicle 10.

According to an embodiment of the present disclosure, the sound apparatus 30 can be configured in an area between the vehicle interior material 130 and the main structure 110 or an area between the vehicle interior material 130 and the exterior material 120. The sound apparatus 30 is placed in an area between the vehicle interior material 130 and the main structure 110 or an area between the vehicle interior material 130 and the exterior material 120, and can output sound S by indirectly or directly vibrating at least one of the areas between the vehicle interior material 130 and the main structure 110 and the areas between the vehicle interior material 130 and the exterior material 120.

According to an embodiment of the present disclosure, the sound apparatus 30 can be arranged in one or more of the region (or first region) between the main structure 110 and the exterior material 120, the region (or second region) between the main structure 110 and the vehicle interior material 130, the exterior material 120, and the vehicle interior material 130. For example, the sound apparatus 30 can be arranged in one or more of the region (or first region) between the main structure 110 and the exterior material 120, the region (or second region) between the main structure 110 and the vehicle interior material 130, the exterior material 120, and the vehicle interior material 130, and can be configured to output sound. For example, the sound apparatus 30 is placed in one or more of the area between the main structure 110 and the exterior material 120 (or the first area), the area between the main structure 110 and the vehicle interior material 130 (or the second area), the exterior material 120, and the vehicle interior material 130, and can output sound by indirectly or directly vibrating one or more of the main structure 110, the exterior material 120, and the vehicle interior material 130.

According to an embodiment of the present disclosure, the sound apparatus 30 can be configured to output sound between the exterior material 120 and the interior material 130 of the vehicle 10. For example, the sound apparatus 30 can be disposed in at least one of a region (or a third region) between the exterior material 120 and the interior material 130, the exterior material 120, and the interior material 130. For example, the sound apparatus 30 can be disposed between the exterior material 120 and the interior material 130, and can indirectly or directly vibrate at least one of the exterior material 120 and the interior material 130 to output sound. For example, the sound apparatus 30 is connected or coupled between the exterior material 120 and the vehicle interior material 130 to at least one of the exterior material 120 and the vehicle interior material 130, and can output sound by indirectly or directly vibrating at least one of the exterior material 120 and the vehicle interior material 130. For example, at least one of the exterior material 120 and the vehicle interior material 130 can output sound S according to the driving (or vibration or displacement) of at least one sound apparatus 30.

According to an embodiment of the present disclosure, at least one of the exterior material 120 and the interior material 130 of the vehicle 10 can be a vibration plate, an acoustic vibration plate, or a sound generating plate for outputting sound S. For example, since each of the exterior material 120 and the vehicle interior material 130 for outputting sound S has a larger size (or area) than the sound apparatus 30, it can function as a large-area vibration plate, acoustic vibration plate, or sound generating plate, thereby improving acoustic characteristics and/or sound pressure characteristics of a sound range including a low-pitched sound range generated by the sound apparatus 30. For example, the sound frequency of the low-pitched sound range can be 300 Hz or less, 400 Hz or less, or 500 Hz or less, but the embodiments of the present disclosure are not limited thereto.

FIG. 9 is a diagram illustrating a sound apparatus according to another aspect of the present disclosure. FIG. 9 illustrates an embodiment implemented by modifying the vehicle interior material 130 on which the sound apparatus described above with reference to FIG. 8 is disposed. Therefore, in the following description, repetitive descriptions of elements other than a vehicle interior material 130 are omitted or will be briefly given.

Referring to FIG. 9, the sound apparatus 30 according to another embodiment of the present disclosure can vibrate a vehicle interior material 130 to output sound S.

The vehicle interior material 130 according to anther embodiment of the present disclosure can include one or more materials of metal, wood, rubber, plastic, glass, fiber, cloth, paper, a mirror, a leather and carbon, but embodiments of the present disclosure are not limited thereto.

The vehicle interior material 130 according to another embodiment of the present disclosure can include a base member 131 and a surface member 133. For example, the base member 131 can be an injection material, a first interior material, an inner interior material, or a rear interior material, but embodiments of the present disclosure are not limited thereto. The surface member 133 can be a second interior material, an outer interior material, a front interior material, an outer surface member, a reinforcement member, or a decoration member, but embodiments of the present disclosure are not limited thereto.

The base member 131 can include a plastic material, but embodiments of the present disclosure are not limited thereto. The base member 131 according to an embodiment of the present disclosure can include an injection material. For example, the base member 131 can be an injection material which is implemented by an injection process using a thermoplastic resin or a thermosetting resin, but embodiments of the present disclosure are not limited thereto. The vehicle interior material 130 or the base member 131 can be configured to cover an inner portion of a vehicle 10. For example, the vehicle interior material 130 or the base member 131 can be configured to cover at least one of the main structure 110 and the exterior material 120 in the indoor space IS of the vehicle 10. For example, the vehicle interior material 130 or the base member 131 can be configured to cover one surface (or an inner surface) of at least one or more of a main frame, a side frame, a door frame, and a handle frame, which are exposed at the indoor space IS of the vehicle 10.

The base member 131 can include one or more of a flat portion and a curved portion. For example, the base member 131 can have a surface structure corresponding to a surface structure of a corresponding vehicle structure, or can have a surface structure which differs from a surface structure of a corresponding vehicle structure.

The surface member 133 can be disposed on the base member 131. The surface member 133 can cover the base member 131 at the inner portion or the indoor space IS of the vehicle 10 and can be exposed at the inner portion or the indoor space IS of the vehicle 10. For example, the surface member 133 can be disposed at or coupled to a front surface (or an interior surface) of the base member 131 exposed at the indoor space IS of the vehicle 10.

The vehicle interior material 130 or the surface member 133 according to an embodiment of the present disclosure can include one or more materials of a fiber, leather, cloth, and wood, but embodiments of the present disclosure are not limited thereto. For example, the surface member 133 can be a fiber material. For example, the surface member 133 including a fiber material can include one or more of a synthetic fiber, a carbon fiber (or an aramid fiber), and a natural fiber, but embodiments of the present disclosure are not limited thereto. For example, the surface member 133 including the fiber material can be a textile sheet, a knit sheet, or a nonwoven fabric, but embodiments of the present disclosure are not limited thereto. For example, the surface member 133 including the fiber material can be a fabric member, but embodiments of the present disclosure are not limited thereto.

The synthetic fiber can be a thermoplastic resin and can include a polyolefin-based fiber which is an eco-friendly material which does not relatively release a harmful substance. For example, the polyolefin-based fiber can include a polyethylene fiber, a polypropylene fiber, or a polyethylene terephthalate fiber, but embodiments of the present disclosure are not limited thereto. The polyolefin-based fiber can be a fiber of a single resin or a fiber of a core-shell structure, but embodiments of the present disclosure are not limited thereto. The natural fiber can be a composite fiber of one or two or more of a jute fiber, a kenaf fiber, an abaca fiber, a coconut fiber, and a wood fiber, but embodiments of the present disclosure are not limited thereto.

The sound apparatus 30 can be covered by the vehicle interior material 130. The sound apparatus 30 can be configured to vibrate the vehicle interior material 130 including the base member 131 and the surface member 133 to output a sound S toward the inner portion or the indoor space IS of the vehicle 10.

The sound apparatus 30 according to another embodiment of the present disclosure can output the sound S toward the indoor space IS of the vehicle 10 by using the vehicle interior material as a vibration plate or a sound vibration plate and can output a realistic sound S or stereo sound including a multichannel toward the indoor space IS of the vehicle 10.

According to another embodiment of the present disclosure, the sound apparatus 30 can be surrounded by an enclosure. A space can be provided between the sound apparatus 30 and the enclosure, and a sound (or a sound pressure level) can be output based on a vibration of the vehicle interior material 130 based on air between the sound apparatus 30 and the enclosure. However, there can be a problem where a sound of the low—pitched sound band is not output, and there can be a problem where the flatness of a sound pressure level is reduced because the number of peaks and dips occurring in a reproduction frequency band of a sound (or a sound pressure level) generated based on a vibration of the vehicle interior material 130 increases and each of a highest sound pressure level and a lowest sound pressure level occurring in a reproduction frequency band of a sound (or a sound pressure level) generated based on a vibration of the vehicle interior material 130 increases. The peak can be a phenomenon where a sound pressure level bounces in a specific frequency, and the dip can be a phenomenon where a low sound pressure level is generated as the occurrence of a sound having a specific frequency is reduced. The flatness of a sound characteristic can be a level of a deviation between a highest sound pressure and a lowest sound pressure.

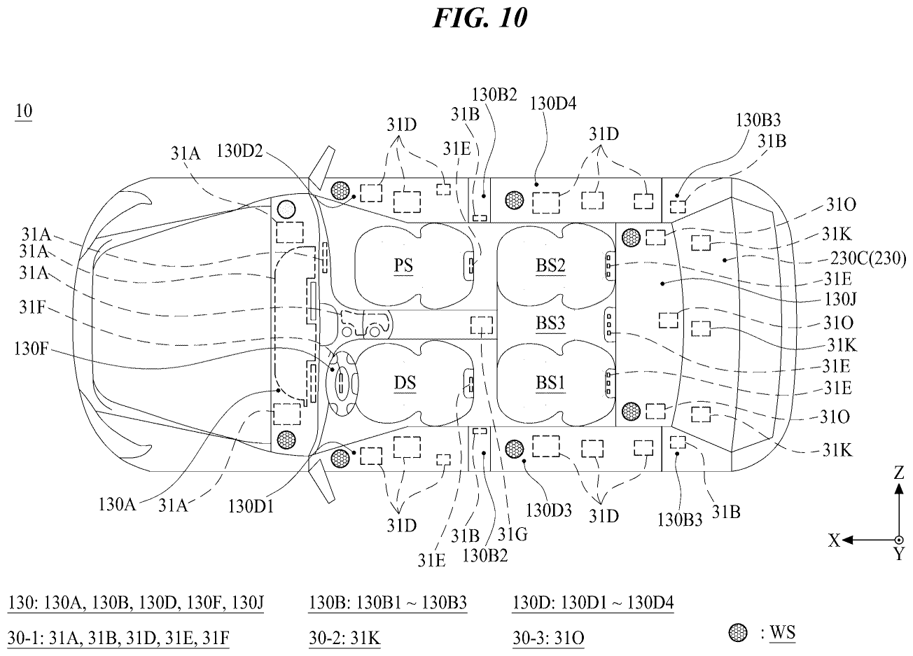

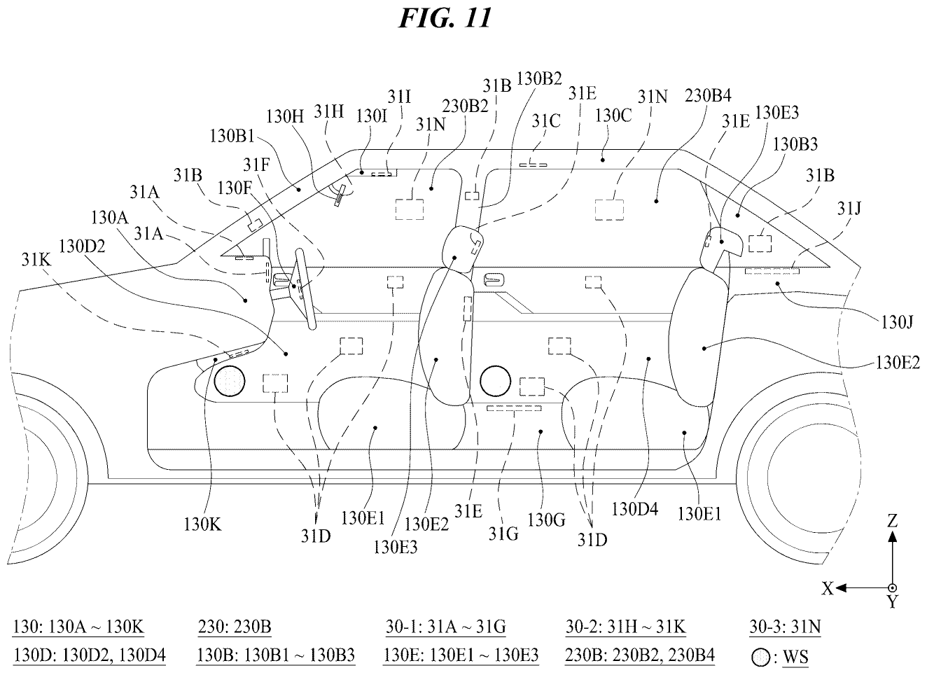

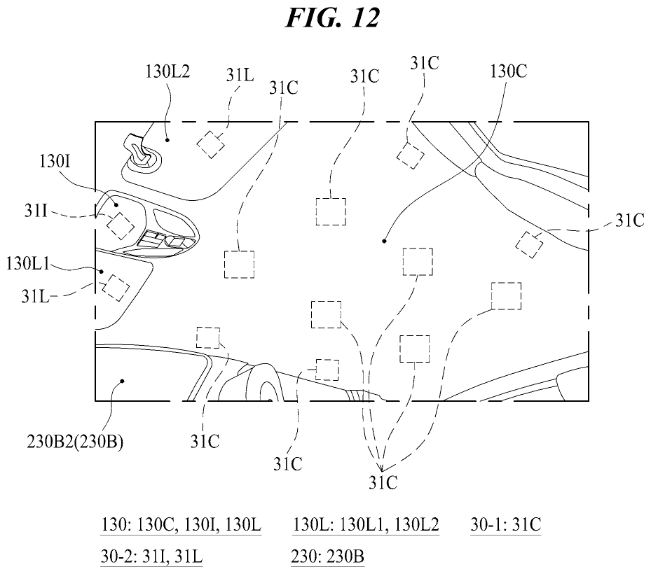

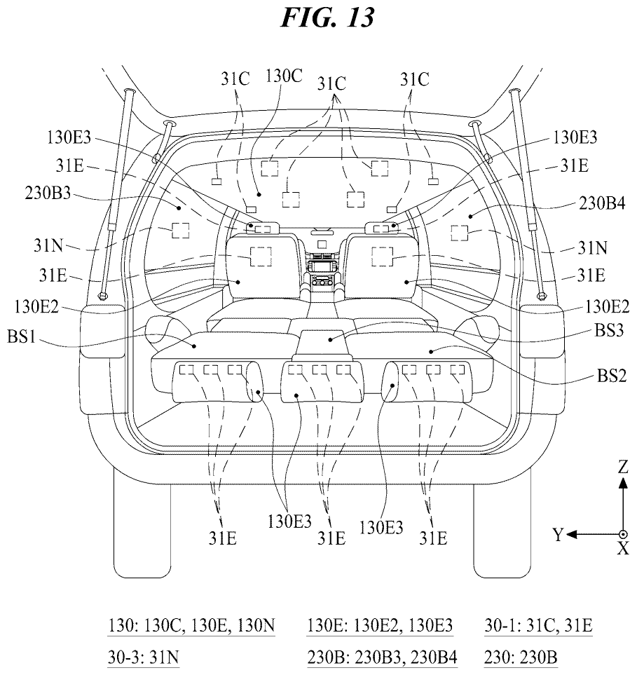

FIG. 10 is a diagram illustrating a vehicular apparatus according to an aspect of the present disclosure. FIG. 11 is a diagram illustrating a vehicular apparatus according to an aspect of the present disclosure. FIG. 12 is a diagram illustrating a sound generating apparatus disposed in the roof of the vehicular apparatus of FIGS. 10 and 11. FIG. 13 is a diagram illustrating a sound generating apparatus disposed in the roof and seat of the vehicular apparatus of FIGS. 10 and 11.

Referring to FIGS. 10 to 13, a vehicular apparatus 10 according to an embodiment of the present disclosure can include a vehicle interior material 130 and a first sound generating apparatus 30-1. For example, the vehicle interior material 130 can output a sound based on a vibration of one or more first sound generating apparatuses 30-1. For example, the vehicle interior material 130 can be exposed at an indoor space.

The first sound generating apparatus 30-1 can include at least one or more of sound generating modules 31A to 31G which are disposed at one or more of a dashboard 130A, a pillar interior material 130B, a roof interior material 130C, a door interior material 130D, a seat interior material 130E, a handle interior material 130F, and a floor interior material 130G. For example, the first sound generating apparatus 30-1 can include at least one or more of the first to seventh sound generating modules 31A to 31G, and thus, can output sounds of one or more channels.

The first sound generating module 31A according to an embodiment of the present disclosure can be disposed between the dashboard 130A and a dash panel and can vibrate the dashboard 130A to output a sound based on a vibration of the dashboard 130A. According to an embodiment of the present disclosure, the first sound generating module 31A can include a sound apparatus 30 described above with reference to FIGS. 1 to 7, and thus, repeated descriptions are omitted. For example, the first sound generating module 31A can be a dashboard speaker.

According to an embodiment of the present disclosure, at least one or more of the dash panel and the dashboard 130A can include a first region corresponding to a driver seat DS, a second region corresponding to a passenger seat PS, and a third region (or a middle region) between the first region and the second region. At least one or more of the dash panel and the dashboard 130A can include a fourth region which is inclined to face the passenger seat PS. According to an embodiment of the present disclosure, the first sound generating module 31A can be disposed to vibrate at least one or more of the first to fourth regions of the dashboard 130A. For example, the first sound generating module 31A can be disposed at each of the first and second regions of the dashboard 130A, or can be disposed at each of the first to fourth regions of the dashboard 130A. For example, the first sound generating module 31A can be disposed at each of the first and second regions of the dashboard 130A, or can be disposed at at least one or more of the first to fourth regions of the dashboard 130A. For example, the first sound generating module 31A can be configured to output a sound of about 150 Hz to about 20 kHz. For example, the first sound generating module 31A configured to vibrate at least one or more of the first to fourth regions of the dashboard 130A can have a same sound output characteristic or different sound output characteristics. For example, the first sound generating module 31A configured to vibrate each of the first to fourth regions of the dashboard 130A can have a same sound output characteristic or different sound output characteristics.

The second sound generating module 31B according to an embodiment of the present disclosure can be disposed between the pillar interior material 130B and a pillar panel and can vibrate the pillar interior material 130B to output a sound based on a vibration of the pillar interior material 130B. For example, the second sound generating module 31B can directly vibrate the pillar interior material 130B to output a sound based on a vibration of the pillar interior material 130B. For example, the second sound generating module 31B can include a sound apparatus 30 described above with reference to FIGS. 1 to 6, and thus, repeated descriptions are omitted. For example, the second sound generating module 31B can be a pillar speaker or a tweeter speaker.

According to an embodiment of the present disclosure, the pillar panel can include a first pillar (or an A pillar) disposed at both sides of a front glass window, a second pillar (or a B pillar) disposed at both sides of a center of a vehicle body, and a third pillar (or a C pillar) disposed at both sides of a rear portion of the vehicle body. The pillar interior material 130B can include a first pillar interior material 130B1 covering the first pillar, a second pillar interior material 130B2 covering the second pillar, and a third pillar interior material 130B3 covering the third pillar. According to an embodiment of the present disclosure, the second sound generating module 31B can be disposed at at least one or more of a region between the first pillar and the first pillar interior material 130B1, a region between the second pillar and the second pillar interior material 130B2, and a region between the third pillar and the third pillar interior material 130B3, and thus, can vibrate at least one or more of the first to third pillar interior materials 130B1 to 130B3. For example, the second sound generating module 31B can be configured to output a sound at about 2 kHz to about 20 kHz, but embodiments of the present disclosure are not limited thereto. For example, the second sound generating module 31B can be configured to output a sound at about 150 Hz to about 20 kHz. For example, the second sound generating module 31B configured to vibrate at least one or more of the first to third pillar interior materials 130B1 to 130B3 can have a same sound output characteristic or different sound output characteristics. The various sound generating modules can be provided in a vehicle display, such as a speedometer or a passenger display such as a detachable tablet or other displays.

Referring to FIGS. 10 to 12, the third sound generating module 31C according to an embodiment of the present disclosure can be disposed between the roof interior material 130C and a roof frame (or a roof panel) and can vibrate the roof interior material 130C to output a sound based on a vibration of the roof interior material 130C. For example, the third sound generating module 31C can directly vibrate the roof interior material 130C to output a sound based on a vibration of the roof interior material 130C. For example, the third sound generating module 31C can include a sound apparatus 30 described above with reference to FIGS. 1 to 6, and thus, repeated descriptions are omitted. For example, the third sound generating module 31C can be a roof speaker.

Referring to FIGS. 10 to 12, the roof interior material 130C can include the first region corresponding to the driver seat DS, the second region corresponding to the passenger seat PS, a third region corresponding to a region between the driver seat DS and the passenger seat PS, a fourth region corresponding to a first rear seat BS1 behind the driver seat DS, a fifth region corresponding to a second rear seat BS2 behind the passenger seat PS, a sixth region corresponding to a third rear seat BS3 between the first rear seat BS1 and the second rear seat BS2, and a seventh region between the third region and the sixth region. For example, the third sound generating module 31C can be disposed to vibrate at least one or more among the first to seventh regions of the roof interior material 130C. For example, the third sound generating module 31C can be configured to output a sound of about 150 Hz to about 20 kHz. For example, the third sound generating module 31C configured to vibrate at least one or more of the first to seventh regions of the roof interior material 130C can have a same sound output characteristic or different sound output characteristics. For example, at least one or more of third sound generating modules 31C configured to vibrate each of the first to seventh regions of the roof interior material 130C can be configured to output a sound of about 2 kHz to about 20 kHz, and the other third sound generating modules 31C can be configured to output a sound of about 150 Hz to about 20 kHz.

Referring to FIGS. 10 and 11, the fourth sound generating module 31D according to an embodiment of the present disclosure can be disposed between the door frame and the door interior material 130D and can vibrate the door interior material 130D to output a sound based on a vibration of the door interior material 130D. According to an embodiment of the present disclosure, the fourth sound generating module 31D can include a sound apparatus 30 described above with reference to FIGS. 1 to 6, and thus, repeated descriptions are omitted. For example, the fourth sound generating module 31D can be a door speaker.

According to an embodiment of the present disclosure, at least one or more of the door frame and the door interior material 130D can include an upper region, a middle region, and a lower region with respect to a height direction Z of the vehicular apparatus 10. For example, the fourth sound generating module 31D can be disposed at at least one or more of the upper region, the middle region, and the lower region between the door frame and the door interior material 130D, and thus, can vibrate at least one or more of the upper region, the middle region, and the lower region of the door interior material 130D.

According to an embodiment of the present disclosure, the upper region of the door interior material 130D can have a relatively small curvature radius. The fourth sound generating module 31D for vibrating the upper region of the door interior material 130D can include the sound apparatus having a flexible characteristic.

According to an embodiment of the present disclosure, the door frame can include a first door frame (or a left front door frame), a second door frame (or a right front door frame), a third door frame (or a left rear door frame), and a fourth door frame (or a right rear door frame). According to an embodiment of the present disclosure, the door interior material 130D can include a first door interior material (or a left front door interior material) 130D1 covering the first door frame, a second door interior material (or a right front door interior material) 130D2 covering the second door frame, a third door interior material (or a left rear door interior material) 130D3 covering the third door frame, and a fourth door interior material (or a right rear door interior material) 130D4 covering the fourth door frame. For example, the fourth sound generating module 31D can be disposed at at least one or more of an upper region, a middle region, and a lower region between each of the first to fourth door frames and the first to fourth door interior materials 130D1 to 130D4 and can vibrate at least one or more of the upper region, the middle region, and the lower region of each of the first to fourth door interior materials 130D1 to 130D4.

According to an embodiment of the present disclosure, the fourth sound generating module 31D configured to vibrate the upper region of each of the first to fourth door interior materials 130D1 to 130D4 can be configured to output a sound of about 2 kHz to about 20 kHz, or can be configured to output a sound of about 150 Hz to about 20 kHz.

According to an embodiment of the present disclosure, the fourth sound generating module 31D configured to vibrate the middle regions and the lower regions of at least one or more of the first to fourth door interior materials 130D1 to 130D4 can be configured to output a sound of about 150 Hz to about 20 kHz. The fourth sound generating module 31D configured to vibrate the middle region and the lower region of each of the first to fourth door interior materials 130D1 to 130D4 can be configured to output a sound of about 150 Hz to about 20 kHz. For example, the fourth sound generating module 31D configured to vibrate the middle regions and the lower regions of at least one or more of the first to fourth door interior materials 130D1 to 130D4 can be one or more of a woofer, a mid-woofer, and a sub-woofer. For example, the fourth sound generating module 31D configured to vibrate the middle region and the lower region of each of the first to fourth door interior materials 130D1 to 130D4 can be one or more of a woofer, a mid-woofer, and a sub-woofer.

Sounds, which are respectively output from the fourth sound generating module 31D disposed at the first door interior material 130D1 and the fourth sound generating module 31D disposed at the second door interior material 130D2, can be combined and output. For example, sounds, which are respectively output from at least one or more of the fourth sound generating module 31D disposed at the first door interior material 130D1 and the fourth sound generating module 31D disposed at the second door interior material 130D2, can be combined and output. In addition, sounds, which are respectively output from the fourth sound generating module 31D disposed at the third door interior material 130D3 and the fourth sound generating module 31D disposed at the fourth door interior material 130D4 can be combined and output.

According to an embodiment of the present disclosure, the upper region of each of the first to fourth door interior materials 130D1 to 130D4 can include a first upper region adjacent to the dashboard 130A, a second upper region adjacent to the rear seats BS1 to BS3, and a third upper region between the first upper region and the second upper region. For example, the fourth sound generating module 31D can be disposed at one or more of the first to third upper regions of each of the first to fourth door interior materials 130D1 to 130D4. For example, the fourth sound generating module 31D can be disposed at the first upper region of each of the first and second door interior materials 130D1 and 130D2 and can be disposed at one or more of the second and third upper regions of each of the first and second door interior materials 130D1 and 130D2. For example, the fourth sound generating module 31D can be disposed at one or more among the first to third upper regions of one or more of the first to fourth door interior materials 130D1 to 130D4. For example, the fourth sound generating module 31D configured to vibrate the first upper regions of one or more of the first and second door interior materials 130D1 and 130D2 can be configured to output a sound of about 2 kHz to about 20 kHz, and the fourth sound generating module 31D configured to vibrate one or more among the second and third upper regions of each of the first and second door interior materials 130D1 and 130D2 can be configured to output a sound of about 2 kHz to about 20 kHz, or can be configured to output a sound of about 150 Hz to about 20 kHz. For example, the fourth sound generating module 31D configured to vibrate one or more among the second and third upper regions of at least one or more of the first and second door interior materials 130D1 and 130D2 can be configured to output a sound of about 2 kHz to about 20 kHz, or can be configured to output a sound of about 150 Hz to about 20 kHz.

Referring to FIGS. 10, 11, and 13, the fifth sound generating module 31E according to an embodiment of the present disclosure can be disposed between a seat frame and the seat interior material 130E and can vibrate the seat interior material 130E to output a sound based on a vibration of the seat interior material 130E. For example, the fifth sound generating module 31E can directly vibrate the seat interior material 130E to output a sound based on a vibration of the seat interior material 130E. For example, the fifth sound generating module 31E can include a sound apparatus 30 described above with reference to FIGS. 1 to 6, and thus, repeated descriptions are omitted. For example, the fifth sound generating module 31E can be a sheet speaker or a headrest speaker.

According to an embodiment of the present disclosure, the seat frame can include a first seat frame (or a driver seat frame), a second seat frame (or a passenger seat frame), a third seat frame (or a first rear seat frame), a fourth seat frame (or a second rear seat frame), and a fifth seat frame (or a third rear seat frame). According to an embodiment of the present disclosure, the seat interior material 130E can include the first seat interior material surrounding the first seat frame, the second seat interior material surrounding the second seat frame, the third seat interior material surrounding the third seat frame, the fourth seat interior material surrounding the fourth seat frame, and the fifth seat interior material surrounding the fifth seat frame.

According to an embodiment of the present disclosure, at least one or more of the first to fifth seat frames can include a seat bottom frame, a seat back frame, and a headrest frame. The seat interior material 130E can include a seat bottom interior material 130E1 surrounding the seat bottom frame, a seat back interior material 130E2 surrounding the seat back frame, and a headrest interior material 130E3 surrounding the headrest frame. At least one or more of the seat bottom interior material 130E1, the seat back interior material 130E2, and the headrest interior material 130E3 can include an inner interior material and an outer interior material. For example, the inner interior material can include a foam layer. For example, the outer interior material can include a surface layer including a fiber or leather. For example, the outer interior material can further include a base layer including a plastic material which supports the surface layer.

According to an embodiment of the present disclosure, the fifth sound generating module 31E can be disposed at at least one or more of a region between the seat back frame and the seat back interior material 130E2 and a region between the headrest frame and the headrest interior material 130E3, and thus, can vibrate at least one or more of the outer interior material of the seat back interior material 130E2 and the outer interior material of the headrest interior material 130E3.

According to an embodiment of the present disclosure, the fifth sound generating module 31E disposed at at least one or more of the driver seat DS and the passenger seat PS can be disposed at at least one or more of the region between the seat back frame and the seat back interior material 130E2 and the region between the headrest frame and the headrest interior material 130E3.

According to an embodiment of the present disclosure, the fifth sound generating module 31E disposed at at least one or more of the first to third rear seats BS1 to BS3 can be disposed between the headrest frame and the headrest interior material 130E3. For example, at least one or more of the first to third rear seats BS1 to BS3 can include at least one or more fifth sound generating modules 31E disposed between the headrest frame and the headrest interior material 130E3.

According to an embodiment of the present disclosure, the fifth sound generating module 31E vibrating the seat back interior materials 130E2 of at least one or more of the driver seat DS and the passenger seat PS can be configured to output a sound of about 150 Hz to about 20 kHz. According to an embodiment of the present disclosure, the fifth sound generating module 31E vibrating the headrest interior materials 130E3 of at least one or more of the driver seat DS, the passenger seat PS, and the first to third rear seats BS1 to BS3 can be configured to output a sound of about 2 kHz to about 20 kHz, or can be configured to output a sound of about 150 Hz to about 20 kHz.

Referring to FIGS. 10 and 11, the sixth sound generating module 31F according to an embodiment of the present disclosure can be disposed between a handle frame and the handle interior material 130F and can vibrate the handle interior material 130F to output a sound based on a vibration of the handle interior material 130F. For example, the sixth sound generating module 31F can directly vibrate the handle interior material 130F to output a sound based on a vibration of the handle interior material 130F. According to an embodiment of the present disclosure, the sixth sound generating module 31F can include a sound apparatus 30 described above with reference to FIGS. 1 to 6, and thus, repeated descriptions are omitted. For example, the sixth sound generating module 31F can be a handle speaker or a steering speaker.

According to an embodiment of the present disclosure, the sixth sound generating module 31F can directly vibrate the handle interior material 130F to provide the driver with the sound based on the vibration of the handle interior material 130F. A sound output by the sixth sound generating module 31F can be a sound which is a same as or different from a sound output from each of the first to fifth sound generating modules 31A to 31E. As an embodiment of the present disclosure, the sixth sound generating module 31F can output a sound which is to be provided to only the driver. As another embodiment of the present disclosure, the sound output by the sixth sound generating module 31F and a sound output by each of the first to fifth sound generating modules 31A to 31E can be combined and output.

Referring to FIGS. 10 and 11, the seventh sound generating module 31G can be disposed between the floor panel and the floor interior material 130G and can indirectly or directly vibrate the floor interior material 130G to output a sound based on a vibration of the floor interior material 130G.

The seventh sound generating module 31G can be disposed between the floor panel and the floor interior material 130G between the front seats DS and PS and the third rear seat BS3. For example, the seventh sound generating module 31G can include a sound apparatus 30 described above with reference to FIGS. 1 to 6, and thus, repeated descriptions are omitted. For example, the seventh sound generating module 31G can be configured to output a sound of about 150 Hz to about 20 kHz. For example, the seventh sound generating module 31G can be a floor speaker, a bottom speaker, or an under speaker.

Referring to FIGS. 10 to 12, the vehicular apparatus or the vehicle 10 according to an embodiment of the present disclosure can further include a second sound generating apparatus 30-2 which is disposed at the vehicle interior material 130 exposed at an indoor space. For example, the vehicular apparatus or the vehicle 10 according to an embodiment of the present disclosure can include only the second sound generating apparatus 30-2 instead of the first sound generating apparatus 30-1, or can include all of the first sound generating apparatus 30-1 and the second sound generating apparatus 30-2.

According to an embodiment of the present disclosure, the vehicle interior material 130 can further include a rear view mirror 130H, an overhead console 130I, a rear package interior material 130J, a glove box 130K, and a sun visor 130L, or the like.

The second sound generating apparatus 30-2 can include at least one or more of sound generating modules 31H to 31L which are disposed at at least one of the rear view mirror 130H, the overhead console 130I, the rear package interior material 130J, the glove box 130K, and the sun visor 130L. For example, the second sound generating apparatus 30-2 can include at least one or more of eighth to twelfth sound generating modules 31H to 31L, and thus, can output sounds of one or more channels.

Referring to FIGS. 10 to 12, the eighth sound generating module 31H can be disposed at the rear view mirror 130H and can indirectly or directly vibrate the rear view mirror 130H to output a sound based on a vibration of the rear view mirror 130H.

The eighth sound generating module 31H can be disposed between a mirror housing connected to a vehicle body structure and the rear view mirror 130H supported by the mirror housing. According to an embodiment of the present disclosure, the eighth sound generating module 31H can include a sound apparatus 30 described above with reference to FIGS. 1 to 6, and thus, repeated descriptions are omitted. For example, the eighth sound generating module 31H can be configured to output a sound of about 150 Hz to about 20 kHz. For example, the eighth sound generating module 31H can be a mirror speaker.

Referring to FIGS. 12 and 13, the ninth sound generating module 31I can be disposed at the overhead console 130I and can indirectly or directly vibrate a console cover of the overhead console 130I to output a sound based on a vibration of an interior material (or the console cover) of the overhead console 130I.

According to an embodiment of the present disclosure, the overhead console 130I can include a console box buried (or embedded) into the roof panel, a lighting device disposed at the console box, and the console cover covering the lighting device and the console box.

The ninth sound generating module 31I can be disposed between the console cover and the console box of the overhead console 130I and can vibrate the console cover. For example, the ninth sound generating module 31I can be disposed between the console cover and the console box of the overhead console 130I and can directly vibrate the console cover. According to an embodiment of the present disclosure, the ninth sound generating module 31I can include a sound apparatus 30 described above with reference to FIGS. 1 to 6, and thus, repeated descriptions are omitted. For example, the ninth sound generating module 31I can be configured to output a sound of about 150 Hz to about 20 kHz. For example, the ninth sound generating module 31I can be a console speaker or a lighting speaker.

According to an embodiment of the present disclosure, the vehicular apparatus or the vehicle 10 can further include a center lighting box disposed at a center region of the roof interior material 130C, a center lighting device disposed at the center lighting box, and a center lighting cover covering the center lighting device. In this case, the ninth sound generating module 31I can be further disposed between a center lighting cover and a center lighting box and can additionally vibrate the center lighting cover.

Referring to FIGS. 10 and 11, the tenth sound generating module 31J can be disposed at the rear package interior material 130J and can indirectly or directly vibrate the rear package interior material 130J to output a sound based on a vibration of the rear package interior material 130J.

The rear package interior material 130J can be disposed behind the first to third rear seats BS1 to BS3. For example, a portion of the rear package interior material 130J can be disposed under a rear glass window 230C.

The tenth sound generating module 31J can be disposed at a rear surface of the rear package interior material 130J and can indirectly or directly vibrate the rear package interior material 130J. According to an embodiment of the present disclosure, the tenth sound generating module 31J can include a sound apparatus 30 described above with reference to FIGS. 1 to 6, and thus, repeated descriptions are omitted. For example, the tenth sound generating module 31J can be a rear speaker.

According to an embodiment of the present disclosure, the rear package interior material 130J can include a first region corresponding to a rear portion of the first rear seat BS1, a second region corresponding to a rear portion of the second rear seat BS2, and a third region corresponding to a rear portion of the third rear seat BS3. According to an embodiment of the present disclosure, the tenth sound generating module 31J can be disposed to vibrate at least one or more of the first to third regions of the rear package interior material 130J. For example, the tenth sound generating module 31J can be disposed at each of the first and second regions of the rear package interior material 130J, or can be disposed at each of the first to third regions of the rear package interior material 130J. For example, the tenth sound generating module 31J can be configured to output a sound of about 150 Hz to about 20 kHz. For example, the tenth sound generating module 31J configured to vibrate at least one or more of the first to third regions of the rear package interior material 130J can have a same sound output characteristic or different sound output characteristics.

Referring to FIGS. 10 and 11, the eleventh sound generating module 31K can be disposed at a glove box 130K and can indirectly or directly vibrate the glove box 130K to output a sound based on a vibration of the glove box 130K.

The glove box 130K can be disposed at a dashboard 130A corresponding to a front portion of the passenger seat PS.

The eleventh sound generating module 31K can be disposed at an inner surface of the glove box 130K and can vibrate the glove box 130K. For example, the eleventh sound generating module 31K can directly vibrate the glove box 130K. According to an embodiment of the present disclosure, the eleventh sound generating module 31K can include a sound apparatus 30 described above with reference to FIGS. 1 to 6, and thus, repeated descriptions are omitted. For example, the eleventh sound generating module 31K can be configured to output a sound of about 150 Hz to about 20 kHz, or can be one or more of a woofer, a mid-woofer, and a sub-woofer. For example, the eleventh sound generating module 31K can be a glove box speaker.

Referring to FIG. 12, the twelfth sound generating module 31L can be disposed at the sun visor 130L and can vibrate the sun visor 130L to output a sound based on a vibration of the sun visor 130L. For example, the twelfth sound generating module 31L can directly vibrate the sun visor 130L to output the sound based on the vibration of the sun visor 130L.

The sun visor 130L can include a first sun visor 130L1 corresponding to the driver seat DS and a second sun visor 130L2 corresponding to the passenger seat PS.

The twelfth sound generating module 31L can be disposed at at least one or more of the first sun visor 130L1 and the second sun visor 130L2 and can vibrate at least one or more of the first sun visor 130L1 and the second sun visor 130L2. For example, the twelfth sound generating module 31L can directly vibrate at least one or more of the first sun visor 130L1 and the second sun visor 130L2. According to an embodiment of the present disclosure, the twelfth sound generating module 31L can include a sound apparatus 30 described above with reference to FIGS. 1 to 6, and thus, repeated descriptions are omitted. For example, the twelfth sound generating module 31L can be configured to output a sound of about 150 Hz to about 20 kHz. For example, the twelfth sound generating module 31L can be a sun visor speaker.

According to an embodiment of the present disclosure, at least one or more of the first sun visor 130L1 and the second sun visor 130L2 can further include a sun visor mirror. In this case, the twelfth sound generating module 31L can be configured to vibrate a sun visor mirror of at least one or more of the first sun visor 130L1 and the second sun visor 130L2. The twelfth sound generating module 31L can directly vibrate the sun visor mirror of at least one or more of the first sun visor 130L1 and the second sun visor 130L2. The twelfth sound generating module 31L vibrating the sun visor mirror can include a sound apparatus 30 described above with reference to FIGS. 1 to 6, and thus, repeated descriptions are omitted.

Referring to FIGS. 10 to 12, the vehicular apparatus or the vehicle 10 according to an embodiment of the present disclosure can further include a third sound generating apparatus 30-3 disposed at a vehicle glass window 230. For example, the vehicular apparatus or the vehicle 10 according to an embodiment of the present disclosure can include the third sound generating apparatus 30-3 instead of at least one or more of the first and second sound generating apparatuses 30-1 and 30-2, or can include all of the first to third sound generating apparatuses 30-1 to 30-3.

The third sound generating apparatus 30-3 can include at least one or more sound generating modules 31N and 31O disposed at the vehicle glass window 230. For example, the third sound generating apparatus 30-3 can include at least one or more of thirteenth and fourteenth sound generating modules 31N and 31O, and thus, can output sounds of one or more channels. For example, the third sound generating apparatus 30-3 can be a transparent sound generating apparatus.

The vehicle glass window 230 of the vehicular apparatus or the vehicle 10 can include at least one or more of a front glass window and a side glass window. The vehicle glass window 230 of the vehicular apparatus can further include at least one or more of a rear glass window and a roof glass window.

The vehicle glass window 230 according to an embodiment of the present disclosure can be configured to be wholly transparent. The vehicle glass window 230 according to another embodiment of the present disclosure can include a transparent portion and a semitransparent portion surrounding the transparent portion. The vehicle glass window 230 according to another embodiment of the present disclosure can include a transparent portion and an opaque portion surrounding the transparent portion.

The vibration apparatus 500 described above with reference to FIGS. 1 to 6 can be configured to be transparent or semitransparent. For example, when the vehicle glass window 230 is wholly transparent, the vibration apparatus 500 can be configured to be transparent and can be disposed at a middle region or a peripheral region of the vehicle glass window 230. When the vehicle glass window 230 includes the semitransparent portion or the opaque portion, the vibration apparatus 500 can be configured to be semitransparent or opaque and can be disposed at the semitransparent portion or the opaque portion of the vehicle glass window 230. For example, the vibration apparatus 500 can be a transparent sound generating module.

Referring to FIGS. 1 to 6 in conjunction with FIG. 10, the vibration apparatus 500 can be disposed at one surface (or an indoor surface) of the vehicle glass window 230 exposed at inside or an indoor space IS of the vehicular apparatus or the vehicle 10. For example, a sound apparatus 30 for vehicles can include at least one or more vibration apparatus 500 disposed at the vehicle glass window 230 or a plurality of the vibration apparatus 500 disposed at the vehicle glass window 230. As an embodiment of the present disclosure, the vibration apparatus 500 can be disposed at at least one or more of the front glass window and the side glass window and can be further disposed at at least one or more of the rear glass window and the roof glass window.

The at least one or more of the thirteenth and fourteenth sound generating modules 31N and 31O can include the transparent or semitransparent vibration apparatus 500. For example, when the at least one or more of the thirteenth and fourteenth sound generating modules 31N and 31O includes the vibration apparatus 500, the at least one or more of the thirteenth and fourteenth sound generating modules 31N and 31O can vibrate the vehicle glass window 230 to output a sound based on a vibration of the vehicle glass window 230. For example, the at least one or more of the thirteenth and fourteenth sound generating modules 31N and 31O can directly vibrate the vehicle glass window 230 to output a sound based on a vibration of the vehicle glass window 230.

According to an embodiment of the present disclosure, the vehicle glass window 230 can include the front glass window, the side glass window 230B, and the rear glass window 230C. According to an embodiment of the present disclosure, the vehicle glass window 230 can further include the roof glass window. For example, when the vehicular apparatus or the vehicle 10 includes the roof glass window, a portion of a region of the roof frame and the roof interior material 130C can be replaced with the roof glass window. For example, when the vehicular apparatus or the vehicle 10 includes the roof glass window, the third sound generating module 31C can be configured to vibrate a periphery portion of the roof interior material 130C surrounding the roof glass window.

Referring to FIGS. 11 to 13, the thirteenth sound generating module 31N according to an embodiment of the present disclosure can be disposed at the side glass window 230B and can be configured to output a sound by vibrating itself (or self-vibration thereof), or can be configured to indirectly or directly vibrate the side glass window 230B to output a sound based on a vibration of the side glass window 230B. For example, the thirteenth sound generating module 31N can directly vibrate the side glass window 230B to output a sound based on the vibration of the side glass window 230B.

According to an embodiment of the present disclosure, the side glass window 230B can include a first side glass window (or a right front window) 230B2, a second side glass window (or a left rear window) 230B3, a third side glass window (or a right rear window) 230B4, and a fourth side glass window (or a left front window).

According to an embodiment of the present disclosure, the thirteenth sound generating module 31N can be disposed at at least one or more of the first to third side glass windows 230B2 to 230B4. For example, at least one or more of the first to third side glass windows 230B2 to 230B4 can include at least one or more thirteenth sound generating module 31N.

For example, the thirteenth sound generating module 31N can be disposed at at least one or more of the first to third side glass windows 230B2 to 230B4 and can output a sound by vibrating itself (or self-vibration thereof), or can vibrate a corresponding side glass windows 230B2 to 230B4 to output a sound. For example, the thirteenth sound generating module 31N can directly vibrate the side glass windows 230B2 to 230B4 to output the sound. For example, the thirteenth sound generating module 31N can be configured to output the sound of 150 Hz to 20 kHz. For example, the thirteenth sound generating module 31N disposed at at least one or more of the first to third side glass windows 230B2 to 230B4 can have a same sound output characteristic or different sound output characteristics. For example, the thirteenth sound generating module 31N disposed at at least one or more of the first to third side glass windows 230B2 to 230B4 can be configured to output the sound of 150 Hz to 20 kHz. For example, the thirteenth sound generating module 31N can be a side window speaker.

Referring to FIG. 11, the fourteenth sound generating module 31O according to an embodiment of the present disclosure can be disposed at the rear glass window 230C and can output a sound by vibrating itself (or self-vibration thereof), or can vibrate the rear glass window 230C to output a sound based on a vibration of the rear glass window 230C. For example, the fourteenth sound generating module 31O can directly vibrate the rear glass window 230C to output the sound based on the vibration of the rear glass window 230C.

According to an embodiment of the present disclosure, the rear glass window 230C can include a first region corresponding to a rear portion of the first rear seat BS1, a second region corresponding to a rear portion of the second rear seat BS2, and a third region corresponding to a rear portion of the third rear seat BS3. According to an embodiment of the present disclosure, the fourteenth sound generating module 31O can be disposed at at least one or more of the first and second regions of the rear glass window 230C. For example, the fourteenth sound generating module 31O can be disposed at at least one or more of the first to third regions of the rear glass window 230C. For example, the fourteenth sound generating module 31O can be disposed at each of the first and second regions of the rear glass window 230C, or can be disposed at each of the first to third regions of the rear glass window 230C. For example, the fourteenth sound generating module 31O can be disposed at at least one or more of the first and second regions of the rear glass window 230C, or can be disposed at at least one or more of the first to third regions of the rear glass window 230C. For example, the fourteenth sound generating module 31O can be configured to output a sound of about 150 Hz to about 20 kHz. For example, the fourteenth sound generating module 31O disposed at at least one or more of the first to third regions of the rear glass window 230C can have a same sound output characteristic or different sound output characteristics. For example, the fourteenth sound generating module 31O disposed at each of the first to third regions of the rear glass window 230C can have a same sound output characteristic or different sound output characteristics. For example, the fourteenth sound generating module 31O disposed at at least one or more of the first and second regions of the rear glass window 230C can be configured to output a sound of about 150 Hz to about 20 kHz, or can be one or more of a woofer, a mid-woofer, and a sub-woofer. For example, the fourteenth sound generating module 31O can be a rear window speaker.

Referring to FIGS. 10 and 11, the vehicular apparatus or the vehicle 10 according to an embodiment of the present disclosure can further include a woofer speaker WS which is disposed at at least one or more of a dashboard 130A, a door frame, and a rear package interior material 130J.

The woofer speaker WS according to an embodiment of the present disclosure can include at least one or more of a woofer, a mid-woofer, and a sub-woofer. For example, the woofer speaker WS can be a speaker which outputs a sound of about 60 Hz to about 150 Hz. Therefore, the woofer speaker WS can output a sound of about 60 Hz to about 150 Hz, and thus, can enhance a low-pitched sound band characteristic of a sound which is output to an indoor space.

According to an embodiment of the present disclosure, the woofer speaker WS can be disposed at at least one or more of first and second regions of the dashboard 130A. According to an embodiment of the present disclosure, the woofer speaker WS can be disposed at each of first to fourth door frames of the door frame and can be exposed at a lower region of each of the first to fourth door interior materials 130D1 to 130D4 of the door interior material 130D. For example, the woofer speaker WS can be disposed at at least one or more of the first to fourth door frames of the door frame and can be exposed at the lower regions of at least one or more of the first to fourth door interior materials 130D1 to 130D4 of the door interior material 130D. According to an embodiment of the present disclosure, the woofer speaker WS can be disposed at at least one or more of the first and second regions of the rear package interior material 130J. For example, the fourth sound generating module 31D disposed at the lower region of at least one or more of the first to fourth door interior materials 130D1 to 130D4 can be replaced by the woofer speaker WS.

The vehicular apparatus according to an embodiment of the present disclosure can further include a garnish member and one or more sound generation apparatus 30 arranged in the vehicle interior material 130. For example, one or more sound generation apparatus 30 can be placed on the garnish member and the vehicle interior material 130 to output sound. For example, at least one of the garnish member and the vehicle interior material 130 can output sound according to the vibration of one or more sound generation apparatus (or vibration apparatus).

The garnish member can be configured to cover a portion of the door interior material 130D exposed at the indoor space, but embodiments of the present disclosure are not limited thereto. For example, the garnish member can be configured to cover a portion of one or more of the dashboard 130A, the pillar interior material 130B, and the roof interior material 130C, which are exposed at the indoor space.

The garnish member according to an embodiment of the present disclosure can include a metal material or a nonmetal material (or a composite nonmetal material) having a material characteristic suitable for generating a sound based on a vibration. For example, a metal material of the garnish member can include any one or more materials of stainless steel, aluminum (Al), an Al alloy, a magnesium (Mg), a Mg alloy, and a magnesium-lithium (Mg—Li) alloy, but embodiments of the present disclosure are not limited thereto. The nonmetal material (or the composite nonmetal material) of the garnish member can include one or more of wood, plastic, glass, cloth, fiber, rubber, paper, carbon, and leather, but embodiments of the present disclosure are not limited thereto. For example, the garnish member can include a metal material having a material characteristic suitable for generating a sound of a high-pitched sound band, but embodiments of the present disclosure are not limited thereto. For example, the high-pitched sound band can have a frequency of 1 kHz or more or 3 kHz or more, but embodiments of the present disclosure are not limited thereto.

As noted above in connection with FIGS. 10 to 13, the vibration apparatus 500 may be incorporated into a body of the vehicular apparatus. The plurality of vehicle interior materials can also be coupled to the body of the vehicular apparatus. In some embodiments, the vehicle interior materials are additional materials removably attached or coupled to the body of the vehicular apparatus. In other embodiments, the vehicle interior materials are integrated into the body, thereby forming part of the body.

In some cases, the vibration apparatus is coupled to either the body or the vehicle interior materials of the vehicular apparatus. Accordingly, in certain cases, the vibration apparatus, under normal operation, is not separated or detached from the body. However, it may be separated in instances where the vehicular apparatus needs repair.

The body of the vehicular apparatus includes a motor mounted to the body. The motor may include a combustion engine, an electric motor, or a hybrid system combining an internal combustion engine (usually fueled by gasoline or diesel) with an electric motor, or the like. Accordingly, in some embodiments, the vehicular apparatus may include not only conventional fuel vehicles but also electric vehicles or other vehicles that run on clean energy.

One or more sound generating apparatus 30 can be placed between the garnish member and the vehicle interior material 130. For example, the one or more sound generation apparatus 30 can be garnish speakers, etc., but the embodiments of the present disclosure are not limited thereto.

One or more sound generation apparatus 30 according to the embodiments of the present disclosure can include the vibration apparatus 500 described with reference to FIGS. 1 to 7B. The one or more sound generation apparatus 30 can be placed on the main interior material or the vehicle interior material 130, and the garnish member, and can be connected or coupled to the garnish member.

One or more sound generation apparatus 30 according to the embodiments of the present disclosure can be configured to indirectly or directly vibrate the garnish member to output sound into the interior space of the transportation device. For example, the one or more sound generation apparatus 30 can be configured to output high-pitched sound, but the embodiments of the present disclosure are not limited thereto.

The vehicular apparatus or the vehicle 10 according to an embodiment of the present disclosure can output a sound to the indoor space through at least one or more of the first sound generating apparatus 30-1 disposed at the vehicle interior material 130, the second sound generating apparatus 30-2 disposed at the vehicle interior material 130 exposed at the indoor space, the third sound generating apparatus 30-3 disposed at the vehicle glass window 230, and the fourth sound generating apparatus disposed at the garnish member, and thus, can output the sound by a vehicle interior material 130 as a vibration plate or a sound vibration plate, thereby outputting a multichannel surround stereo sound.

A vibration apparatus and vehicular apparatus comprising same according to example embodiments of the present disclosure are described below.

A vibration apparatus according to one or more embodiments of the present disclosure can comprises a cover member having first and second areas, a vibration part in each of the first and second areas, and a support member between the cover member and the vibration part.

According to one or more embodiments of the present disclosure, the vibration part can include a first vibration part in the first area, and a plurality of second vibration parts in the second area.

According to one or more embodiments of the present disclosure, the first area can be smaller than the second area in size.

According to one or more embodiments of the present disclosure, each of the plurality of second vibration parts can be smaller than the first vibration part in size.

According to one or more embodiments of the present disclosure, each of the first vibration part and the plurality of second vibration parts can include a vibration layer including a piezoelectric material, a first electrode layer on a first surface of the vibration layer, and a second electrode layer on a second surface different from the first surface of the vibration layer. The vibration layers of the first vibration part and the second vibration part can have different sizes.

According to one or more embodiments of the present disclosure, the vibration layer of the second vibration part can have a size smaller than that of the vibration layer of the first vibration part.

According to one or more embodiments of the present disclosure, the first electrode layer of the first vibration part and the first electrode layer of the second vibration part can be electrically connected to each other.

According to one or more embodiments of the present disclosure, the support member can include a first support member between the cover member and the first vibration part, and a second support member between the cover member and the second vibration part. The first support member and the second support member can include the same material.

According to one or more embodiments of the present disclosure, the first support member and the second support member can have different thicknesses.

According to one or more embodiments of the present disclosure, the vibration apparatus can further comprise a flexible part configured between the first vibration part and the second vibration part and between each of the plurality of second vibration parts. The flexible part can be on a rear surface of the first support member.

According to one or more embodiments of the present disclosure, the cover member can further include a third area parallel to the second area, and the first to third areas can have the same length.

According to one or more embodiments of the present disclosure, the vibration part can further include a third vibration part in the third area.

According to one or more embodiments of the present disclosure, each of the first to third vibration parts can include a vibration layer including a piezoelectric material, a first electrode layer on a first surface of the vibration layer, and a second electrode layer on a second surface different from the first surface of the vibration layer. The vibration layers of the first vibration part and the third vibration part can have the same size, and the vibration layers of the first vibration part and the second vibration part can have different sizes.

According to one or more embodiments of the present disclosure, the vibration layer of the first vibration part can be larger than the vibration layer of the second vibration part in size.

According to one or more embodiments of the present disclosure, the first electrode layer of the first vibration part can be electrically connected to the first electrode layer of the second vibration part, and the first electrode layer of the second vibration part and the first electrode layer of the third vibration part can be electrically connected to each other.

According to one or more embodiments of the present disclosure, the support member can include a first support member between the cover member and the first vibration part, a second support member between the cover member and the plurality of second vibration parts, and a third support member between the cover member and the third vibration part. The first to third support members can include the same material.

According to one or more embodiments of the present disclosure, the first support member and the second support member can have different thicknesses, and the first support member and the third support member can have the same thickness.

According to one or more embodiments of the present disclosure, the vibration apparatus can further comprise a flexible part between the first vibration part and the second vibration part and between the second vibration part and the third vibration part. The flexible part can be disposed on a rear surface of the first support member and a rear surface of the third support member.

According to one or more embodiments of the present disclosure, the support member can include a first support member between the cover member and the first vibration part, a second support member between the cover member and the plurality of second vibration parts, and a third support member between the cover member and the third vibration part. The first and second support members can include different materials, and the first and third support members can include the same material.

According to one or more embodiments of the present disclosure, the first to third support members can have the same thickness.

According to one or more embodiments of the present disclosure, each of the first to third support members can include a support plate, and a protrusion vertically protruding from facing sides of the support plate.

According to one or more embodiments of the present disclosure, the support plates of each of the first support member and the second support member can have different thicknesses, and the support plates of the first support member and the third support member can have the same thickness.

According to one or more embodiments of the present disclosure, the protrusions of the first support member and the second support member can have different thicknesses, and the protrusions of the first support member and the third support member can have the same thickness.

According to one or more embodiments of the present disclosure, a thickness of the support plate of the first support member can be smaller than a thickness of the support plate of the second support member, and a thickness of the protrusion of the first support member can be greater than a thickness of the protrusion of the second support member.

According to one or more embodiments of the present disclosure, vibration apparatus can further comprise a flexible part between the first vibration part and the second vibration part adjacent to each other and between the second vibration part and the third vibration part. The flexible part can be disposed on a rear surface of the support plate in each of the first support member and the third support member.

According to one or more embodiments of the present disclosure, the support member can include at least any one of aluminum Al, copper Cu, and plastic.

According to one or more embodiments of the present disclosure, the thickness of the support member can be 0.5 to 2.0 times the thickness of the vibration layer.

According to one or more embodiments of the present disclosure, the cover member can include a first cover member on a first surface of the vibration part, and a second cover member on a second surface different from the first surface of the vibration part. The support member can be between the vibration part and the first cover member.

According to one or more embodiments of the present disclosure, the vibration apparatus can further comprise a signal cable connected to the vibration part. The signal cable can include a first signal line between the vibration part and the first cover member and a second signal line between the vibration part and the second cover member.

A vehicular apparatus according to one or more embodiments of the present disclosure can comprises an interior material exposed to an indoor space, and at least one sound generating apparatus configured to output sound to the indoor space. The at least one sound generating apparatus can include a vibration apparatus comprising a cover member having first and second areas, a vibration part in each of the first and second areas, and a support member between the cover member and the vibration part.

According to one or more embodiments of the present disclosure, the interior material can include one or more among metal, wood, rubber, plastic, carbon, glass, fiber, cloth, paper, mirror, and leather.

According to one or more embodiments of the present disclosure, the interior material can include at least one of a dashboard, a pillar interior material, a roof interior material, a door interior material, a seat interior material, a handle interior material, a floor interior material, a rear package interior material, an overhead console, a rear view mirror, a glove box, a garnish member, and a sun visor, and the at least one sound generating apparatus can generate sound by vibrating at least one of the dashboard, the pillar interior material, the roof interior material, the door interior material, the seat interior material, the handle interior material, the floor interior material, the rear package interior material, the overhead console, the rear view mirror, the glove box, the garnish member, and the sun visor.

A vibration apparatus according to one or more embodiments of the present disclosure can be applied to or included in a vibration apparatus disposed in an apparatus. The apparatus according to one or more example embodiments of the present disclosure can be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. In addition, the vibration apparatus according to some example embodiments of the present disclosure can be applied to or included in organic light-emitting lighting apparatuses or inorganic light-emitting lighting apparatuses. When the vibration apparatus according to one or more example embodiments of the present disclosure is applied to or included in lighting apparatuses, the vibration apparatus can act as a lighting device and a speaker.

In addition, when the vibration apparatus according to some example embodiments of the present disclosure is applied to or included in a mobile device, or the like, the vibration apparatus can be one or more of a speaker, a receiver, and a haptic device, but embodiments of the present disclosure are not limited thereto.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vibration apparatus comprising:
a cover member having first and second areas;
a vibration part in each of the first and second areas; and
a support member between the cover member and the vibration part.

2. The vibration apparatus according to claim 1,
wherein the vibration part includes:
a first vibration part in the first area; and
a plurality of second vibration parts in the second area.

3. The vibration apparatus according to claim 1, wherein the first area is smaller than the second area in size.

4. The vibration apparatus according to claim 2, wherein each of the plurality of second vibration parts is smaller than the first vibration part in size.

5. The vibration apparatus according to claim 2,
wherein each of the first vibration part and the plurality of second vibration parts includes:
a vibration layer including a piezoelectric material, the vibration layer having a first surface and a second surface different from the first surface;
a first electrode layer on the first surface of the vibration layer; and
a second electrode layer on the second surface of the vibration layer,
wherein the vibration layers of the first vibration part and the second vibration part have different sizes.

6. The vibration apparatus according to claim 5, wherein the vibration layer of the second vibration part has a size smaller than that of the vibration layer of the first vibration part.

7. The vibration apparatus according to claim 5, wherein the first electrode layer of the first vibration part and the first electrode layer of the second vibration part are electrically connected to each other.

8. The vibration apparatus according to claim 2,
wherein the support member includes:
a first support member between the cover member and the first vibration part, the first support member having a first surface; and
a second support member between the cover member and the second vibration part,
wherein the first support member and the second support member include a same material.

9. The vibration apparatus according to claim 8, wherein the first support member and the second support member have different thicknesses.

10. The vibration apparatus according to claim 8, further comprising:
a flexible part configured between the first vibration part and the second vibration portion and between each of the plurality of second vibration parts,
wherein the flexible part is on the first surface of the first support member.

11. The vibration apparatus according to claim 2,
wherein the cover member further includes a third area parallel to the second area, and
wherein the first to third areas have a same length from a plan view.

12. The vibration apparatus according to claim 11, wherein the vibration part further includes a third vibration part in the third area.

13. The vibration apparatus according to claim 12,
wherein each of the first to third vibration parts includes:
a vibration layer including a piezoelectric material;
a first electrode layer on a first surface of the vibration layer; and
a second electrode layer on a second surface different from the first surface of the vibration layer,
wherein the vibration layers of the first vibration part and the third vibration part have a same size, and
the vibration layers of the first vibration part and the second vibration part have different sizes.

14. The vibration apparatus according to claim 13, wherein the vibration layer of the first vibration part is larger than the vibration layer of the second vibration part in size.

15. The vibration apparatus according to claim 13,
wherein the first electrode layer of the first vibration part is electrically connected to the first electrode layer of the second vibration part, and
wherein the first electrode layer of the second vibration part and the first electrode layer of the third vibration part are electrically connected to each other.

16. The vibration apparatus according to claim 12,
wherein the support member includes:
a first support member between the cover member and the first vibration part, the first support member having a first surface;
a second support member between the cover member and the plurality of second vibration parts; and
a third support member between the cover member and the third vibration part, the third support member having a second surface,
wherein the first to third support members include a same material.

17. The vibration apparatus according to claim 16,
wherein the first support member and the second support member have different thicknesses, and
wherein the first support member and the third support member have the same thickness.

18. The vibration apparatus according to claim 12,
wherein the support member includes:
a first support member between the cover member and the first vibration part;
a second support member between the cover member and the plurality of second vibration parts; and
a third support member between the cover member and the third vibration part,
wherein the first and second support members include different materials,
wherein the first and third support members include a same material.

19. A vehicular apparatus comprising:
a body having a motor mounted therein;
a plurality of vehicle interior materials coupled to the body; and
a vibration apparatus coupled to at least one vehicle interior material of the plurality of vehicle interior materials, the vibration apparatus including:
a cover member having first and second areas;
a vibration part in each of the first and second areas, the vibration part including:
a first vibration part in the first area; and
a plurality of second vibration parts in the second area; and
a support member between the cover member and the vibration part.
wherein each of the plurality of second vibration parts is smaller than the first vibration part in size.

20. The vehicular apparatus according to claim 19,
wherein each of the first vibration part and the plurality of second vibration parts includes:
a vibration layer including a piezoelectric material, the vibration layer having a first surface and a second surface different from the first surface;
a first electrode layer on the first surface of the vibration layer; and
a second electrode layer on the second surface of the vibration layer,
wherein the vibration layers of the first vibration part and the second vibration part have different sizes.
